(19) United States
(12) Patent Application Publication
(10) Pub. No.: US 2026/0288057 A1
(43) Pub. Date: Sep. 24, 2026

(54) METHOD OF CLEANING DEVELOPING AGENT STUCK TO IMAGE CARRIER IN IMAGE FORMING APPARATUS

(71) Applicant: CANON KABUSHIKI KAISHA, Tokyo (JP)

(72) Inventors: NAOKI FUKUSHIMA, Shizuoka (JP); HIROKAZU FUJINO, Shizuoka (JP); YUTARO NAKAMURA, Shizuoka (JP); YOSUKE KISHI, Shizuoka (JP)

(21) Appl. No.: 19/567,442

(22) Filed: Mar. 16, 2026

(30) Foreign Application Priority Data
Mar. 19, 2025 (JP) 2025-045617
Sep. 17, 2025 (JP) 2025-154411

(51) Int. Cl. G03G 21/18; G03G 15/00; G03G 21/00; G03G 21/12

(52) U.S. Cl. CPC G03G 21/1814; G03G 15/55; G03G 21/0023; G03G 21/12; G03G 21/1875

(57) ABSTRACT

An image forming apparatus features a control unit that executes supply processing when a process cartridge is new but the apparatus itself is not. To supply a developing agent between a cleaning unit and an image carrier, a developing unit forms a developing agent image on the rotating image carrier. A voltage applying unit then applies a first polarity voltage to a transfer unit, transferring the image from the image carrier to the transfer unit during a first period. During a second period, the applying unit applies a second polarity voltage to the transfer unit, transferring the developing agent image from the transfer unit back to the image carrier.

### BACKGROUND

### Field of the Technology

The present disclosure relates to a method of cleaning a developing agent stuck to an image carrier in an image forming apparatus.

### Description of the Related Art

An image forming apparatus forms an image on a sheet using toner. Toner that remains on a photosensitive drum without being transferred onto the sheet is cleaned using a cleaning blade. The cleaning performance degrades when paper dust sticks to the cleaning blade. Japanese Patent Laid-Open No. 2016-075768 proposes a method of removing paper dust trapped between a photosensitive drum and a cleaning blade by rotating the photosensitive drum in reverse after image formation is complete. Japanese Patent Laid-Open No. S63-172295 proposes supplying toner to an area of contact between a photosensitive drum and a cleaning blade during a non-image-forming period in which an image is not formed on a sheet. This removes paper dust trapped between the photosensitive drum and the cleaning blade.

Incidentally, it is also important to form a lubricating layer of toner at an area of contact between a photosensitive drum and a cleaning blade. If no lubricating layer is present, the performance of the cleaning blade in paper dust cleaning will worsen. A sufficient lubricating layer is not formed on the cleaning blade of new process cartridges in particular. New process cartridges are often mounted in image forming apparatuses that are not new and in which paper dust has therefore accumulated. The performance of a cleaning blade in paper dust cleaning worsens when the lubricating layer is insufficient, which causes a variety of problems.

### SUMMARY

The disclosure provides an image forming apparatus comprising: an image carrier; a drive unit configured to rotationally drive the image carrier; a developing unit configured to supply a developing agent to the image carrier being rotationally driven and form a developing agent image; a transfer unit configured to transfer the developing agent image from the rotationally driven image carrier to a recording medium; an applying unit configured to apply a voltage of a first polarity or a voltage of a second polarity to the transfer unit; a cleaning unit that is disposed downstream of the transfer unit in a rotation direction of the image carrier and configured to clean a surface of the image carrier by coming into contact with the rotationally driven image carrier; a process cartridge configured to house the image carrier, the developing unit, and the cleaning unit; and a control unit configured to control the drive unit, the developing unit, and the applying unit. The control unit is configured to execute supply processing for supplying a developing agent between the cleaning unit and the image carrier in a case where the image forming apparatus is not new and the process cartridge is new. The supply processing includes: rotationally driving the image carrier by the drive unit; forming a first developing agent image on the image carrier by the developing unit; applying, by the applying unit, a transfer voltage of the first polarity to the transfer unit to transfer the first developing agent image from the image carrier to the transfer unit in a first period including a period in which the first developing agent image carried on the image carrier passes the transfer unit; and applying, by the applying unit, a transfer voltage of the second polarity to the transfer unit to transfer the developing agent image from the transfer unit to the image carrier in a second period after the first developing agent image carried on the image carrier passes the transfer unit.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are diagrams illustrating an image forming apparatus and a process cartridge.

FIG. 2 is a diagram illustrating a controller.

FIG. 3 is an enlarged view of a cleaning contact part.

FIGS. 4A and 4B are diagrams illustrating an initial purge.

FIG. 5 is a flowchart illustrating an initial purge according to a comparative example.

FIG. 6 is a flowchart illustrating an initial purge according to a first embodiment.

FIGS. 7A and 7B are diagrams illustrating evaluation results.

FIG. 8 is a diagram illustrating an initial purge according to a second embodiment.

FIG. 9 is a flowchart illustrating the initial purge according to the second embodiment.

FIGS. 10A and 10B are diagrams illustrating a post-rotation purge.

FIG. 11 is a flowchart illustrating a post-rotation purge.

FIG. 12 is a diagram illustrating evaluation results.

FIG. 13 is a diagram illustrating a post-rotation purge.

FIGS. 14A to 14C are diagrams illustrating the axial direction and purge length of a transfer roller 5.

FIG. 15 is a diagram illustrating evaluation results according to a fourth embodiment.

FIG. 16 is a diagram illustrating evaluation results according to a fifth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. First Embodiment

### 1-1. Image Forming Apparatus

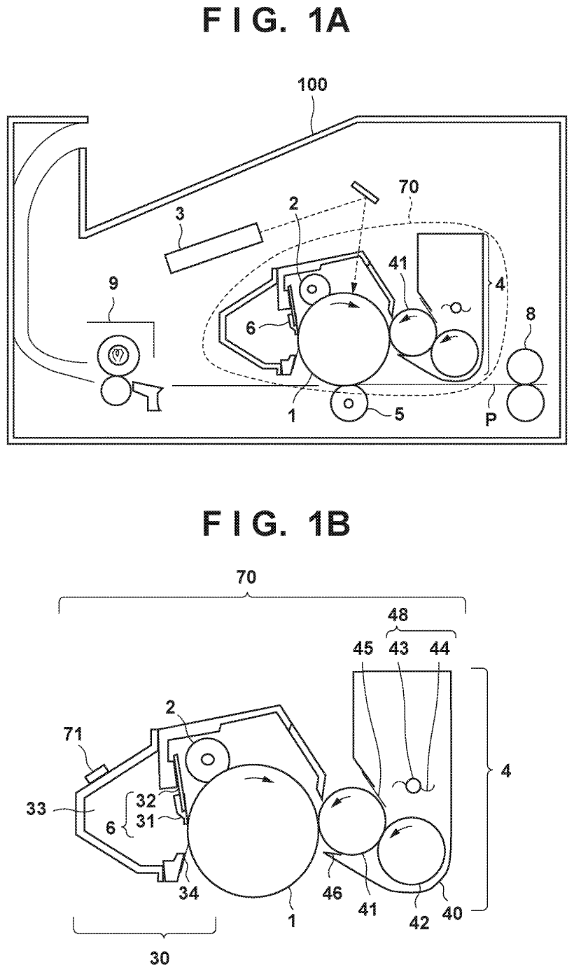

In FIG. 1A, an image forming apparatus 100 is an electrophotographic printer. The image forming apparatus 100 may be implemented as a product, as a copier, a facsimile device, a multifunction peripheral (multifunction printer), or the like, for example.

The image forming apparatus 100 includes a process cartridge 70 that can be mounted in/removed from the image forming apparatus 100. A photosensitive drum 1 is an example of an image carrier that is rotationally driven by a motor or the like.

The process cartridge 70 axially supports the photosensitive drum 1 such that the photosensitive drum 1 is rotatable. A charging roller 2 provided in the process cartridge 70 charges the surface of the rotating photosensitive drum 1. A scanner unit 3 is disposed above the process cartridge 70. The scanner unit 3 is an exposure device that forms an electrostatic latent image on the photosensitive drum 1 by irradiating the rotating photosensitive drum 1 with light. A developing roller 41 of a developing device 4 is a developing member that forms a developing agent image (a toner image) by developing the electrostatic latent image using a developing agent (toner). A transfer roller 5 is a transfer member that rotates in contact with the photosensitive drum 1. A transfer nip is formed between the transfer roller 5 and the photosensitive drum 1. A conveyance roller pair 8 conveys a recording medium P to the transfer nip. The toner image is transferred from the photosensitive drum 1 to the recording medium P as a result of the transfer roller 5 and the photosensitive drum 1 rotating while nipping the recording medium P. A voltage called a transfer bias is applied to the transfer roller 5. The transfer bias instigates the transfer of the toner image from the photosensitive drum 1 to the recording medium P. The recording medium P is conveyed to a fixing device 9. The fixing device 9 fixes the toner image onto the recording medium P by applying heat and pressure to the recording medium P and the toner image. The recording medium P is then discharged to the exterior of the image forming apparatus 100.

### 1-2. Process Cartridge

FIG. 1B is a schematic cross-sectional view of the process cartridge 70. The process cartridge 70 includes a cleaning device 30 and the developing device 4. The cleaning device 30 includes the photosensitive drum 1, the charging roller 2, and a cleaning blade 6. The charging roller 2, the developing roller 41, the transfer roller 5, the cleaning blade 6, and the like are disposed around the photosensitive drum 1. However, the transfer roller 5 is provided outside the process cartridge 70. In other words, the transfer roller 5 is a part of the main body of the image forming apparatus 100. The cleaning device 30 includes the cleaning blade 6, a collection chamber 33, and a scooping sheet 34. The cleaning blade 6 has a rubber blade 31 and a support member 32 that supports the rubber blade 31. A tip of the rubber blade 31 protrudes in the direction opposite from the rotation direction of the photosensitive drum 1 and comes into contact with the photosensitive drum 1. The collection chamber 33 is a collecting container that collects toner and paper dust removed from the surface of the photosensitive drum 1 by the cleaning blade 6. The scooping sheet 34 comes into contact with the photosensitive drum 1 to prevent the toner contained in the collection chamber 33 from leaking out from the collection chamber 33. When drive force from a motor serving as a drive source is transmitted to the cleaning device 30, the photosensitive drum 1 rotates. The charging roller 2 is rotatably attached to the cleaning device 30 and rotates in accordance with the photosensitive drum 1.

The developing device 4 includes a developing frame 40, the developing roller 41, a toner supply roller 42, a developing blade 45, and a blowout prevention sheet 46. The developing roller 41 is a developing member (rotating body) that rotates in contact with the photosensitive drum 1. The developing frame 40 supports the developing roller 41, the toner supply roller 42, the developing blade 45, the blowout prevention sheet 46, and the like. The toner supply roller 42 is disposed in the periphery of the developing roller 41, and rotates in contact with the developing roller 41. Toner is supplied to the surface of the developing roller 41 as a result. The developing blade 45 is a regulation member that regulates the thickness of a toner layer on the developing roller 41. The developing blade 45 charges the toner to a negative polarity. A developing bias is applied to the developing roller 41. The developing bias is a voltage that assists the toner charged to the negative polarity to stick to the photosensitive drum 1 through frictional electrification. The toner sticks to a surface that is exposed by the scanner unit 3 to a light part potential, and does not stick to a surface that is not exposed and is therefore at a dark part potential. The blowout prevention sheet 46 prevents toner from leaking from the developing frame 40 that comes into contact with the developing roller 41.

A toner conveyance member 48 is provided in a toner storage chamber 47 of the developing frame 40. The toner conveyance member 48 has an agitation shaft 43 and a sheet member 44. The agitation shaft 43 is rotated by drive force from the exterior and rotates with the sheet member 44. The sheet member 44 agitates the toner contained in the toner storage chamber 47 and conveys the toner to the toner supply roller 42.

The process cartridge 70 includes a memory 71. The memory 71 is a non-volatile storage medium. The memory 71 stores usage information (e.g., information indicating whether the process cartridge 70 is new and a cumulative toner consumption amount) and lifespan information (e.g., the total toner amount, in the case of a new product) of the process cartridge 70. When the power of the image forming apparatus 100 is switched from off to on, or when the process cartridge 70 is replaced with a new one, the information stored in the memory 71 is read out. This makes it possible to accurately and quickly calculate the usage status and the replacement time (lifespan) of the process cartridge 70.

### 1-3. Controller

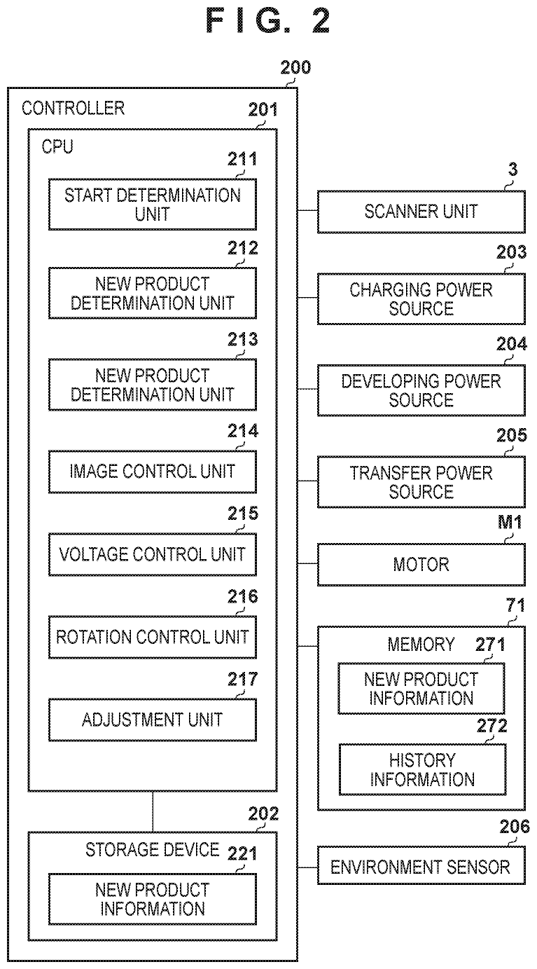

FIG. 2 illustrates a controller 200 of the image forming apparatus 100. The controller 200 includes a CPU 201 and a storage device 202. The CPU 201 controls the image forming apparatus 100 by executing control programs stored in the storage device 202. The storage device 202 can include a variety of storage media, such as a read-only memory (ROM), a random access memory (RAM), a hard disk drive (HDD), a solid-state drive (SSD), and the like. The CPU 201 implements a plurality of functions by executing the control programs. Some or all of the plurality of functions may be implemented by hardware such as application-specific integrated circuits (ASICs) or field-programmable gate arrays (FPGAs).

A start determination unit 211 determines whether cleaning is to be started for the photosensitive drum 1 or the transfer roller 5. Here, the cleaning includes an initial purge executed when the process cartridge 70 is new, and a normal purge executed when image defects (streaks) are likely to occur due to insufficient cleaning. Start conditions are stored in the storage device 202 in advance. The start conditions for the initial purge include the process cartridge 70 being new, for example. The start conditions for the initial purge may be, for example, that the process cartridge 70 is new and the image forming apparatus 100 is not new. The start conditions for the normal purge may be that a difference between a cumulative number of printed sheets the previous time the normal purge was performed and the cumulative number of printed sheets obtained at the time of the start determination is at least a threshold. The start condition for the normal purge may be that a print job has ended. The memory 71 of the process cartridge 70 may store history information 272. The history information 272 includes the cumulative number of printed sheets for the process cartridge 70. When the process cartridge 70 is new, the cumulative number of printed sheets of the process cartridge 70 is zero. The start determination unit 211 may determine whether cleaning is to be started based on determination results from new product determination units 212 and 213.

The new product determination unit 212 reads out new product information 271 from the memory 71 installed in the process cartridge 70, and determines whether the process cartridge 70 is new based on the new product information 271. The CPU 201 rewrites the new product information 271 when the process cartridge 70 is used to form an image, for example. As a result, the new product information 271 is rewritten with information indicating that the process cartridge 70 is not new. Note that the new product information 271 may be a fuse that blows when the process cartridge 70 is mounted in the image forming apparatus 100 and is electrified by the image forming apparatus 100. In this case, the new product determination unit 212 can determine whether the process cartridge 70 is new according to whether the fuse is blown.

The new product determination unit 213 determines whether the image forming apparatus 100 is new. The new product determination unit 213 reads out new product information 221 from the storage device 202 and determines whether the image forming apparatus 100 is new based on the new product information 221. The CPU 201 rewrites the new product information 221 when the image forming apparatus 100 is used to form an image for the first time, for example. As a result, the new product information 221 is rewritten with information indicating that the image forming apparatus 100 is not new. In particular, the new product determination unit 213 may determine whether the transfer roller 5 is new.

An image control unit 214 controls the scanner unit 3 and causes the scanner unit 3 to form an electrostatic latent image for a purge image. The “purge image” is a toner image for cleaning the transfer roller 5 and forming a lubricating layer between the tip of the cleaning blade 6 and the photosensitive drum 1. An electrostatic latent image for the purge image is developed into a toner image by the developing device 4.

A voltage control unit 215 controls a charging power source 203, causes the charging power source 203 to generate a charging bias, and causes the charging bias to be applied to the charging roller 2. The surface of the photosensitive drum 1 is uniformly charged as a result. The voltage control unit 215 controls a developing power source 204, causes the developing power source 204 to generate a developing bias, and causes the developing bias to be applied to the developing roller 41. As a result, the electrostatic latent image is developed, and the toner image is formed on the photosensitive drum 1. The voltage control unit 215 controls a transfer power source 205, causes the transfer power source 205 to generate a transfer bias, and causes the transfer bias to be applied to the transfer roller 5. When the toner image is transferred from the photosensitive drum 1 to the recording medium P, a voltage of a first polarity (e.g., positive polarity) is applied to the transfer roller 5. As a result, the toner image carried on the photosensitive drum 1 moves toward the recording medium P and the transfer roller 5 more easily. When a lubricating layer is formed on the cleaning blade 6 or the lubricating layer is fortified, a transfer voltage of a second polarity (e.g., negative polarity) is applied to the transfer roller 5. This is to suppress situations where the toner image for forming the lubricating layer (the purge image) remains on the transfer roller 5.

Processing for fortifying the lubricating layer is performed in a non-image-forming period in which the recording medium P is not passing through the transfer nip formed between the transfer roller 5 and the photosensitive drum 1. The toner image carried on the photosensitive drum 1 therefore directly comes into contact with the transfer roller 5. Accordingly, by applying a negative-polarity transfer bias to the transfer roller 5, the toner is subjected to a force in a direction away from the transfer roller 5 and toward the photosensitive drum 1. This suppresses situations where the toner sticks to the transfer roller 5.

A rotation control unit 216 controls a motor M1 and causes the motor M1 to rotationally drive the photosensitive drum 1, the developing roller 41, the transfer roller 5, and the like.

An adjustment unit 217 adjusts the amount of toner contained in the purge image, the length or printing ratio of the purge image in a rotation direction (a sub scanning direction) of the photosensitive drum 1, and the like. For example, the adjustment unit 217 may perform adjustment processing based on environmental conditions detected by an environment sensor 206 (e.g., ambient temperature and ambient humidity), or based on the history information 272. For example, under environmental conditions where paper dust sticks to the transfer roller 5 easily, the amount of toner contained in the purge image may be increased. Under environmental conditions where paper dust does not stick to the transfer roller 5 easily, the amount of toner contained in the purge image may be reduced.

The transfer roller 5 transfers the toner image on the photosensitive drum 1 to the recording medium P, but toner may remain on the photosensitive drum 1. Accordingly, the CPU 201 causes the cleaning blade 6 to remove transfer residue (e.g., toner and paper dust) on the photosensitive drum 1 by continuously rotating the photosensitive drum 1 after a print job end.

### 1-4. Formation of Lubricating Layer by Toner Purge

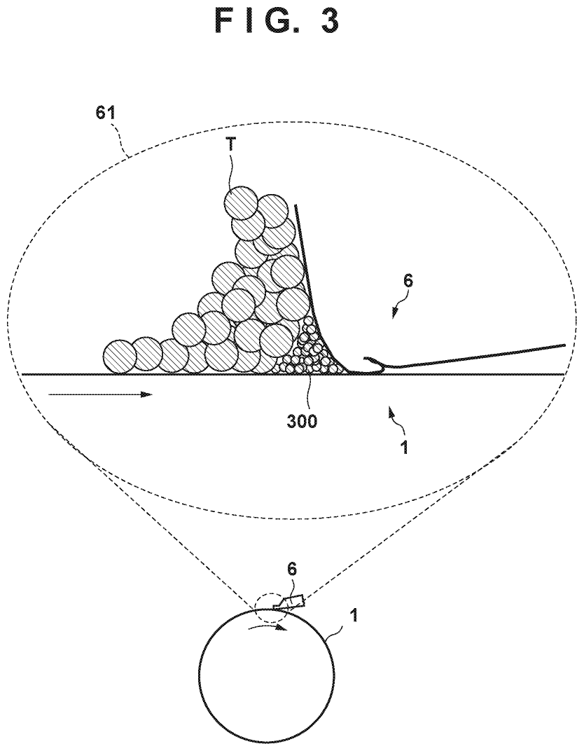

FIG. 3 is an enlarged view of a cleaning contact part 61. The cleaning contact part 61 is an area of contact between the cleaning blade 6 and the photosensitive drum 1. The CPU 201 forms a lubricating layer 300 for the cleaning blade 6 by supplying toner T on the photosensitive drum 1 during non-image-formation.

As described above, the transfer residue on the photosensitive drum 1 is cleaned using the cleaning blade 6 that comes into contact with the photosensitive drum 1. The tip of the cleaning blade 6 that comes into contact with the photosensitive drum 1 (the rubber blade 31) is formed as an elastic body. Friction acts on the cleaning contact part 61. A large amount of friction may cause the elastic body of the cleaning blade 6 to flip or develop nicks. Accordingly, toner is supplied to the cleaning contact part 61 during non-image-formation.

As a result, additives (additive particles) such as silica present on the surface of the toner T transfer from the developing device 4 to the photosensitive drum 1, and the additives are carried to the tip of the cleaning blade 6 by the photosensitive drum 1. The lubricating layer 300, which serves as a barrier layer, is formed as a result.

Providing the lubricating layer 300 reduces the friction acting between the cleaning blade 6 and the photosensitive drum 1. This suppresses flipping and nicking in the cleaning blade 6, and maintains the cleaning performance of the cleaning blade 6. Specifically, situations where toner and paper dust stuck to the photosensitive drum 1 are transferred to the charging roller 2 are suppressed.

Here, “non-image-formation” refers to a time when the recording medium P is not passing through the transfer nip.

For example, non-image-formation includes pre-multi-rotation, pre-rotation, an inter-sheet process, post-rotation, and standby.

“Pre-multi-rotation” refers to the motor M1 rotationally driving the photosensitive drum 1 to execute predetermined preparatory operations in a starting operation period (startup operation period; warming period) of the image forming apparatus 100. Pre-multi-rotation is performed when the power of the image forming apparatus 100 is switched from off to on, and when a maintenance door of the image forming apparatus 100 is opened and closed.

Pre-rotation is a process executed following pre-multi-rotation when a print start signal has been input during pre-multi-rotation. If the pre-multi-rotation period ends without the print start signal being input, the rotational driving of the photosensitive drum 1 is stopped, and the image forming apparatus 100 remains stopped until a print start signal is input. When a print start signal is input during the stopped state, the motor M1 restarts, the photosensitive drum 1 rotates, and pre-rotation is performed.

The “inter-sheet process” is a process executed when images are printed continuously on a plurality of sheets of the recording medium P. “Inter-sheet” refers to a period from when a following end of the recording medium P passes the transfer roller 5 to the when the leading end of the next recording medium P reaches the transfer roller 5. In other words, “inter-sheet” refers to a period in which the recording medium P is not passing the transfer roller 5 in a print job in which images are printed continuously on a plurality of sheets of the recording medium P.

“Post-rotation” refers to a period during which predetermined post-operations (post-rotation) is executed. “Post-rotation” refers to the photosensitive drum 1 continuing to rotate even after the printing onto the last recording medium P in a print job has ended.

“Standby” refers to a period in which the post-rotation has ended and the rotational drive of the photosensitive drum 1 is stopped. During standby, the image forming apparatus 100 stands by for the next print start signal to be input.

Incidentally, a toner purge (a normal purge) is executed each time the number of printed sheets becomes at least a threshold. For example, after the number of printed sheets becomes at least a threshold, a normal purge is executed in the first instance of non-image-formation (e.g., during post-rotation or during the inter-sheet process). The start conditions for the normal purge may be relaxed the more severe the environmental conditions become. In other words, the adjustment unit 217 may adjust the start conditions such that the normal purge is performed more frequently as the environmental conditions become more severe. In addition, the adjustment unit 217 may adjust the start conditions such that the normal purge is performed more frequently as the cumulative number of printed sheets of the image forming apparatus 100 (a usage history) increases. Note that the start conditions may be adjusted according to a usage rate of the photosensitive drum 1, which is calculated from a rotation time and a charging time of the photosensitive drum 1.

### 1-5. Drop in Cleaning Performance Due to Paper Dust

The lubricating layer 300 is formed and maintained by toner supplied by a toner purge. The toner and the additives that form the lubricating layer 300 gradually slip past the cleaning contact part 61 due to the rotational movement of the photosensitive drum 1. The lubricating layer 300 may also gradually decrease due to the circulation of toner remaining on the cleaning contact part 61. Paper dust (paper fibers and filler) from the recording medium P transfers to the photosensitive drum 1 and enters the lubricating layer 300. This accelerates the reduction of the lubricating layer 300.

To maintain a stable lubricating layer 300, toner purges are performed periodically or during post-rotation. A transfer bias of a polarity opposite from the polarity used during image formation is applied to the transfer roller 5, and the toner image on the photosensitive drum 1 is supplied to the cleaning contact part 61. This reforms the lubricating layer 300 and keeps the lubricating layer 300 stable until the process cartridge 70 reaches the end of its lifespan.

On the other hand, paper dust from the recording medium P also sticks to the transfer roller 5. Paper dust stuck to the transfer roller 5 also transfers to the photosensitive drum 1. The photosensitive drum 1 conveys the paper dust to the cleaning contact part 61, and the lubricating layer 300 may therefore be broken down by the paper dust. As the potential difference between the transfer roller 5 and the photosensitive drum 1 increases, paper dust sticking to the transfer roller 5 transfers to the photosensitive drum 1 more easily. The paper dust is charged when it slides along the transfer roller 5 or the photosensitive drum 1.

Furthermore, because a force corresponding to the potential difference between the transfer roller 5 and the photosensitive drum 1 acts on the paper dust, the paper dust sticking to the transfer roller 5 transfers to the photosensitive drum 1. When filler contained in the paper dust polarizes due to dielectric relaxation, it becomes easier for the paper dust to transfer to the photosensitive drum 1.

Although the lubricating layer 300 is stabilized by the toner purge executed during post-rotation, the paper dust conveyed from the transfer roller 5 partially breaks down the lubricating layer 300. When the photosensitive drum 1 rotates while the lubricating layer 300 is reduced, nicks form in parts of the cleaning blade 6, or residual toner escapes past the cleaning blade 6. This results in the charging roller 2 being soiled by toner and causes charging defects.

An insufficient lubricating layer 300 is formed when the process cartridge 70 is new. Accordingly, paper dust conveyed from the transfer roller 5 to the cleaning blade 6 has a greater effect on the lubricating layer 300.

In the first embodiment, the new product determination unit 213 determines whether the image forming apparatus 100 (and the transfer roller 5 in particular) is new based on the new product information 221. When the transfer roller 5 is not new (when the transfer roller 5 is likely to be carrying paper dust), the CPU 201 intentionally causes toner to stick to the transfer roller 5, and causes the toner to electrostatically or physically stick to the paper dust carried by the transfer roller 5. The CPU 201 then retransfers the toner and paper dust stuck to the transfer roller 5 to the photosensitive drum 1, and the toner and paper dust is then collected using the cleaning blade 6. This reduces paper dust sticking to the transfer roller 5. When the toner sticks to the paper dust, a mixture of toner and the paper dust is produced. The particles in this mixture are larger than the particles of the paper dust alone, which makes it easier for the cleaning blade 6 to collect the paper dust that is part of the mixture.

### 1-6. Initial Purge

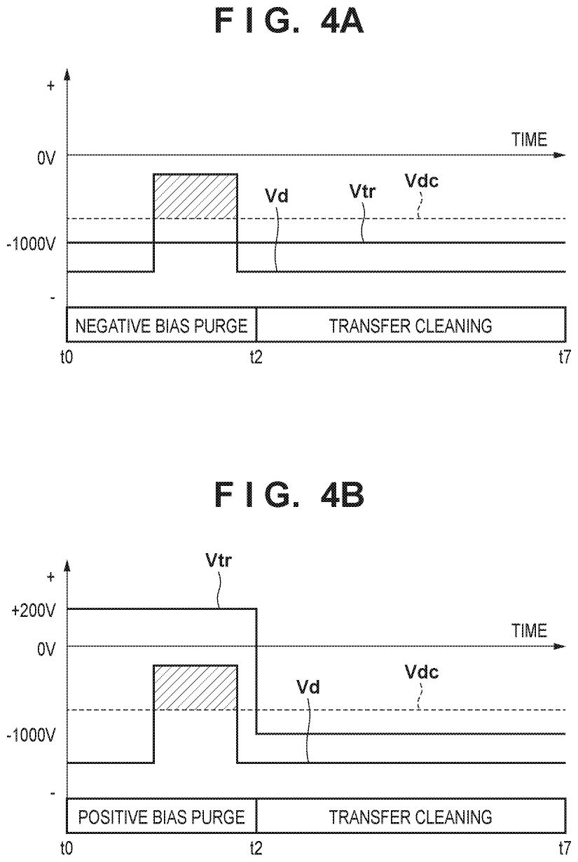

FIG. 4A illustrates the timing at which a bias is applied in an initial purge according to a comparative example. FIG. 4B illustrates the timing at which a bias is applied in an initial purge according to the first embodiment. The comparative example is not a conventional technique, but rather a downgraded version in which some functions of the first embodiment have been omitted. The vertical axis represents voltage. The horizontal axis represents time. The origin on the horizontal axis represents, for example, the timing at which the new process cartridge 70 is mounted in the image forming apparatus 100 (the timing at which the maintenance door is closed). Here, the initial purge is started at this timing. Vdc represents the developing bias. Vtr represents the transfer bias. Vd represents the charging bias. The hatched part represents a period during which the purge image comes into contact with the transfer roller 5.

As illustrated in FIG. 4A, the initial purge in the comparative example is constituted by a “negative bias purge” and “transfer cleaning”. The negative bias purge is executed in a period from time t0 to time t2. The transfer cleaning is executed in a period from time t2 to time t7. The negative bias purge is a toner purge using a negative-polarity transfer bias Vtr. The transfer cleaning is rotating the photosensitive drum 1 and the transfer roller 5 in a state where purge toner (the purge image) is not carried on the photosensitive drum 1.

Upon starting the initial purge, the CPU 201 forms a toner image on the photosensitive drum 1 by an image formation operation including charging, exposure, development, and transfer. The purge image is 50 mm long in the sub scanning direction, for example. Although the transfer roller 5 may have a circumferential length of 50 mm, for example, the circumferential length of the transfer roller 5 is assumed to be 44 mm here. A length of the purge image in a main scanning direction orthogonal to the sub scanning direction is equal to a width of the photosensitive drum 1, for example. The width of the photosensitive drum 1 is the length of the photosensitive drum 1 in a direction parallel to the axis of rotation of the photosensitive drum 1.

It is necessary for the transfer bias Vtr applied to the transfer roller 5 to effectively supply the toner, supplied from the developing device 4, to the cleaning contact part 61. The polarity of the transfer bias Vtr is negative. The transfer bias Vtr is continuously applied to the transfer roller 5 (a negative bias purge) during two rotations of the transfer roller 5. Accordingly, the length of the period during which the negative bias purge is executed is double a rotation period Tc of the transfer roller 5 (=2×Tc). In FIGS. 4A and 4B, the difference between time ti and time ti+1 is Tc. i is an integer greater than or equal to 0.

If the polarity of the transfer bias Vtr is negative, almost none of the purge image is transferred to the transfer roller 5. However, a trace amount of toner may stick to the transfer roller 5. Accordingly, transfer cleaning is necessary in order to retransfer the toner, transferred to the transfer roller 5, to the photosensitive drum 1. In the transfer cleaning, the transfer roller 5 is rotated five times while the negative-polarity transfer bias Vtr is applied. Accordingly, the length of the period during which the transfer cleaning is executed is five times the rotation period Tc of the transfer roller 5 (=5×Tc).

The transfer bias Vtr used in the negative bias purge and the transfer cleaning may be set in consideration of a resistance value of the transfer roller 5, a resistance value of the photosensitive drum 1, and the environmental conditions. For example, under environmental conditions where the ambient temperature is 23° C. and the ambient humidity is 50%, the transfer bias Vtr may be −1,000 V.

As illustrated in FIG. 4B, the initial purge according to the first embodiment includes a positive bias purge and transfer cleaning. “Positive bias purge” refers to intentionally transferring a purge image to the transfer roller 5 using a positive-polarity transfer bias Vtr. The positive bias purge is executed in a period from time t0 to time t2. The transfer cleaning is executed in a period from time t2 to time t7. The length of the period during which the positive bias purge is executed is double the rotation period Tc of the transfer roller 5 (=2×Tc).

In the positive bias purge, the application of the positive-polarity transfer bias Vtr to the transfer roller 5 is started at a timing t0, which is when the leading end of the purge image arrives at the transfer nip. The toner forming the purge image is transferred from the photosensitive drum 1 to the transfer roller 5 as a result. The size of the purge image is as described earlier with reference to FIG. 4A.

The positive-polarity transfer bias Vtr is continuously applied to the transfer roller 5 during two rotations of the transfer roller 5. The toner forming the purge image is transferred to the transfer roller 5 as a result. The specific value of the positive-polarity transfer bias Vtr may be set in consideration of the resistance value of the transfer roller 5, the resistance value of the photosensitive drum 1, and the environmental conditions. For example, under environmental conditions where the ambient temperature is 23° C. and the ambient humidity is 50%, the transfer bias Vtr may be +200 V.

Like the comparative example, the transfer cleaning is executed in the first embodiment. The length of the period during which the transfer cleaning is executed is five times the rotation period Tc of the transfer roller 5 (=5×Tc).

In this manner, the initial purge according to the comparative example includes a negative bias purge using the negative-polarity transfer bias Vtr. This is effective when the transfer roller 5 is new and paper dust is not stuck to the transfer roller 5. The initial purge according to the first embodiment includes a positive bias purge using the positive-polarity transfer bias Vtr. This is effective when the transfer roller 5 is not new and paper dust is stuck thereto. According to the first embodiment, the lubricating layer 300 in particular is properly maintained, which makes image defects less likely to occur. In addition, toner sticks to the paper dust on the transfer roller 5, and the paper dust to which the toner sticks is collected by the cleaning blade 6. This reduces the probability of the paper dust being conveyed to the cleaning blade 6 by itself, which makes it less likely that the cleaning blade 6 will be damaged. Downtime during which the user cannot form images is reduced as a result.

### 1-7. Flowchart

### 1-7-1. Initial Purge (Negative Bias Purge)

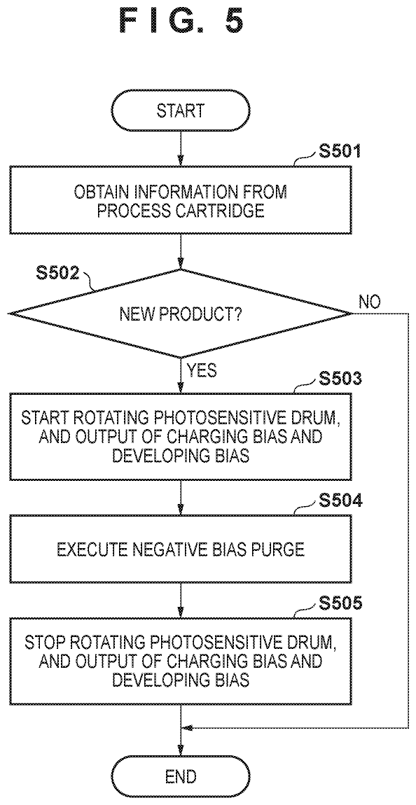

FIG. 5 illustrates the initial purge according to the comparative example. The CPU 201 executes the following processing when the power of the image forming apparatus 100 is switched from off to on, or when the process cartridge 70 is replaced. For example, the following processing is executed when the maintenance door (not shown) is opened and closed.

In step S501, the CPU 201 (the new product determination unit 213) obtains information from the memory 71 of the process cartridge 70. Here, the information is the new product information 271.

In step S502, the CPU 201 (the new product determination unit 213) determines whether the process cartridge 70 is new based on the new product information 271. If the process cartridge 70 is not new, it is not necessary to form the lubricating layer 300. The CPU 201 therefore ends the initial purge.

However, if the process cartridge 70 is new, it is necessary to form the lubricating layer 300. The CPU 201 therefore moves from step S502 to step S503.

In step S503, the CPU 201 (the voltage control unit 215 and the rotation control unit 216) starts rotating the photosensitive drum 1, applying the charging bias Vd, and applying the developing bias Vdc to form the purge image on the photosensitive drum 1. For example, the charging bias Vd is −1,100 V. The developing bias Vdc is −400 V.

In step S504, the CPU 201 (the image control unit 214, the voltage control unit 215, and the rotation control unit 216) executes the negative bias purge. The CPU 201 controls the scanner unit 3 to form an electrostatic latent image on the photosensitive drum 1, and causes the developing device 4 to form the purge image using toner. When the photosensitive drum 1 rotates, the purge image is conveyed to the transfer roller 5. As illustrated in FIG. 4A, the transfer bias Vtr is set to a negative bias (e.g., −1,000 V). As a result, the purge image is conveyed to the cleaning blade 6 with almost no sticking to the transfer roller 5. The lubricating layer 300 is formed as a result. The transfer cleaning is executed once the negative bias purge is complete.

In step S505, once the transfer cleaning is complete, the CPU 201 (the rotation control unit 216 and the voltage control unit 215) stops the rotation of the photosensitive drum 1, the output of the charging bias Vd, and the output of the developing bias Vdc. The output of the transfer bias Vtr is also stopped.

### 1-7-2. Initial Purge (Positive Bias Purge)

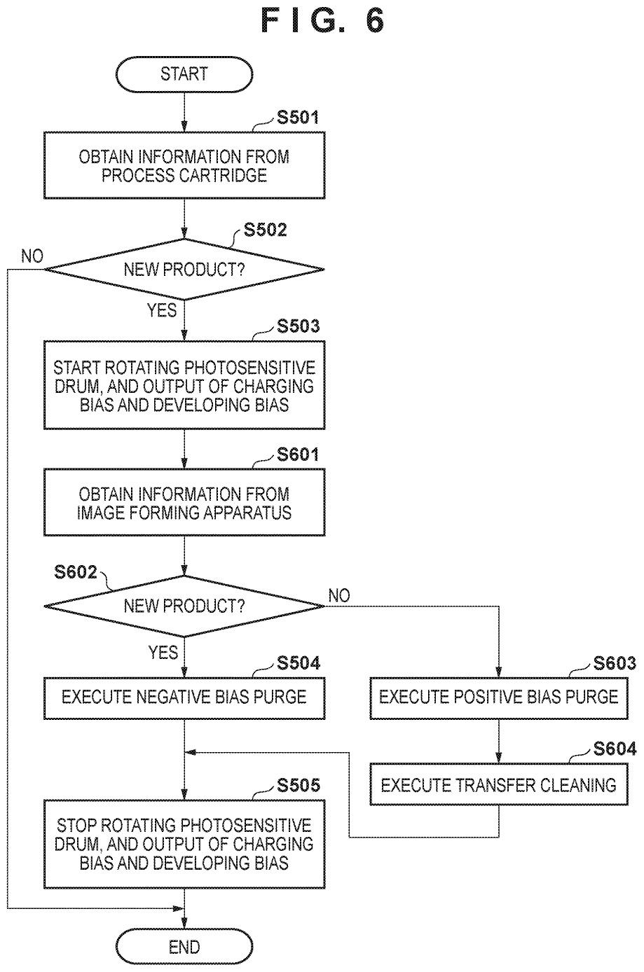

FIG. 6 illustrates the initial purge (the positive bias purge) according to the first embodiment. Of the steps in FIG. 6, steps that are the same as in FIG. 5 are given the same reference signs, and the same descriptions apply. As illustrated in FIG. 6, steps S601 to S604 are added after step S503.

In step S601, the CPU 201 (the new product determination unit 212) obtains information from the storage device 202 of the image forming apparatus 100. Here, the information is the new product information 221.

In step S602, the CPU 201 (the new product determination unit 212) determines whether the image forming apparatus 100 (e.g., the transfer roller 5) is new based on the new product information 221. If both the process cartridge 70 and the image forming apparatus 100 are new, the CPU 201 moves from step S602 to step S504. The negative bias purge is executed as a result. However, if the process cartridge 70 is new but the image forming apparatus 100 is not new, the CPU 201 moves from step S602 to step S603.

In step S603, the CPU 201 (the image control unit 214, the voltage control unit 215, and the rotation control unit 216) executes the positive bias purge. The CPU 201 controls the scanner unit 3 to form an electrostatic latent image on the photosensitive drum 1, and causes the developing device 4 to form the purge image using toner. When the photosensitive drum 1 rotates, the purge image is conveyed to the transfer roller 5. As illustrated in FIG. 4B, the transfer bias Vtr is set to a positive bias (e.g., +200 V). Most of the purge image is therefore transferred to the transfer roller 5.

In step S604, the CPU 201 (the voltage control unit 215 and the rotation control unit 216) executes the transfer cleaning. The CPU 201 switches the transfer bias Vtr from a positive polarity bias (e.g., +200 V) to a negative polarity bias (e.g., −1,000 V). As a result, the toner is re-transferred from the transfer roller 5 to the photosensitive drum 1, and conveyed to the cleaning blade 6 by the photosensitive drum 1. At this time, paper dust sticking to the transfer roller 5 is also collected on the photosensitive drum 1 along with the toner, and is conveyed to the cleaning blade 6. As a result, the paper dust is removed from the transfer roller 5, and the lubricating layer 300 is properly fortified.

Although the present embodiment describes a 50 mm purge image being formed on the photosensitive drum 1 as the initial purge, this is merely one example. The amount of toner supplied, the number of times toner is supplied, and the timing at which toner is supplied may be adjusted according to the usage environment and the usage state of the main unit of the image forming apparatus 100.

### 1-8. Evaluation Experiments

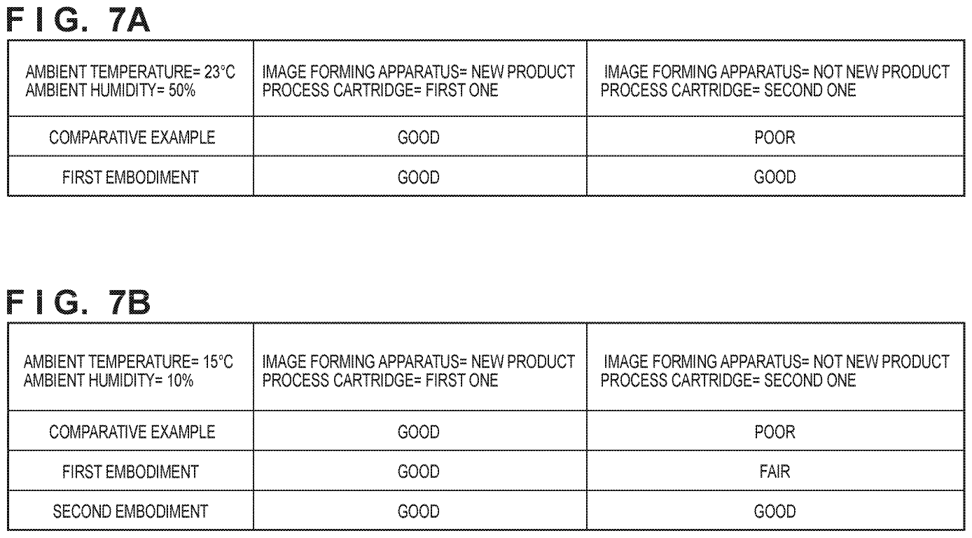

FIG. 7A illustrates results of experiments conducted according to the comparative example and the first embodiment. An ambient temperature of 23° C. and an ambient humidity of 50% were used as conditions of the experiment. Images were formed on 10,000 sheets of the recording medium P at a printing ratio of 2%. A halftone image having a printing ratio of 25% was then formed on a single sheet of the recording medium P. In FIGS. 7A and 7B, “good” means that streak-shaped images extending parallel to the conveyance direction of the recording medium P (vertical streaks) did not occur. “Poor” means that vertical streaks occurred.

In the comparative example, vertical streaks did not occur in the first new process cartridge 70.

When the toner in the first process cartridge 70 was exhausted, the first process cartridge 70 was replaced with a second new process cartridge 70. The image forming apparatus 100 continued to form images while using the second process cartridge 70. Vertical streaks occurred in the halftone image while the second process cartridge 70 was being used. This is because the charging roller 2 was soiled with toner due to poor cleaning of the photosensitive drum 1. In other words, paper dust stuck to the transfer roller 5 while the first process cartridge 70 was being used. The lubricating layer 300 was formed in the initial purge for the second process cartridge 70. However, paper dust collided with the cleaning contact part 61 before a stable lubricating layer 300 was formed in the initial purge. As a result, the lubricating layer 300 was broken down by the paper dust, and some residual toner slipped through. The toner that slipped through stuck to the charging roller 2, and local charging defects occurred. The toner concentration increased at the locations where the charging defects occurred, resulting in black vertical streaks.

On the other hand, according to the first embodiment, vertical streaks did not occur in the second process cartridge 70 as well. This is because the positive bias purge was executed when the first process cartridge 70 was replaced with the second process cartridge 70. In the positive bias purge, the purge image for forming the lubricating layer 300 is transferred to the transfer roller 5, and paper dust and toner are retransferred to the photosensitive drum 1 together. The integrated paper dust and toner then arrive at the cleaning blade 6, the lubricating layer 300 is properly formed by the toner, and the paper dust is removed. This makes it difficult for the charging roller 2 to be soiled by toner.

According to the first embodiment, the control of the initial purge is changed in accordance with an operation history of the process cartridge 70 and an operation history of the image forming apparatus 100. As a result, the lubricating layer 300 is properly formed, and the cleaning performance of the cleaning blade 6 is maintained. This makes image defects less likely to occur. The initial purge may be skipped if the process cartridge 70 is not new. Through this, downtime due to the initial purge may be reduced.

### 1-9. Summary of First Embodiment

The photosensitive drum 1 is an example of an image carrier. The motor M1 is an example of a drive unit that rotationally drives the image carrier. The developing device 4 is an example of a developing unit that forms a developing agent image by supplying a developing agent to the image carrier being rotationally driven. The transfer roller 5 is an example of a transfer unit that transfers the developing agent image from the image carrier being rotationally driven to the recording medium P. The transfer power source 205 is an example of an applying unit that applies a voltage of a first polarity or a voltage of a second polarity to the transfer unit. The cleaning device 30 is an example of a cleaning unit that is disposed downstream from the transfer unit in a rotation direction of the image carrier and that cleans a surface of the image carrier by coming into contact with the image carrier being rotationally driven. The process cartridge 70 is an example of a process cartridge that houses the image carrier, the developing unit, and the cleaning unit. The controller 200 and the CPU 201 are examples of a control unit that controls the drive unit, the developing unit, and the applying unit. The controller 200 executes supply processing for supplying the developing agent between the cleaning unit and the image carrier when the image forming apparatus 100 is not new and the process cartridge 70 is new. For example, the controller 200 is configured to execute lubricating layer formation processing (e.g., the initial purge) that forms a lubricating layer between the cleaning unit and the image carrier when the image forming apparatus 100 is not new and the process cartridge 70 is new. As illustrated in FIG. 6 and the like, the lubricating layer formation processing includes a plurality of steps. Step S503 is an example of the drive unit rotationally driving the image carrier. Step S603 is an example of the developing unit forming a first developing agent image on the image carrier. Step S603 is an example of the applying unit applying a transfer voltage of the first polarity to the transfer unit to transfer the first developing agent image from the image carrier to the transfer unit in a first period including a period in which the first developing agent image carried on the image carrier passes the transfer unit. Step S604 is an example of the applying unit applying a transfer voltage of the second polarity to the transfer unit to transfer the developing agent image and a sticking substance from the transfer unit to the image carrier in a second period after the first developing agent image carried on the image carrier has passed the transfer unit. Through this, the performance of the cleaning member can be increased for a combination of a process cartridge that is new and an image forming apparatus that is not new.

The memory 71 is an example of a holding unit that holds information indicating whether the process cartridge 70 is new (e.g., the new product information 271). The controller 200 may determine whether the process cartridge 70 is new based on the information held by the holding unit.

The storage device 202 is an example of a storage unit that stores information indicating whether the image forming apparatus 100 is new (e.g., the new product information 221). The controller 200 may determine whether the image forming apparatus 100 is new based on the information stored in the storage unit.

The transfer roller 5 is an example of a rotating body. As suggested by FIG. 4B, the length of the purge image in the sub scanning direction may be at least the circumferential length of the transfer roller 5. This makes it possible to transfer toner to the entire circumferential surface of the transfer roller 5.

The cleaning blade 6 and the rubber blade 31 are examples of a cleaning member, having a blade-like shape, that comes into contact with the image carrier. The collection chamber 33 is an example of a collecting container that collects the developing agent image and the sticking substance collected by the cleaning member. Paper dust is an example of the sticking substance. The lubricating layer 300 is formed at the cleaning contact part 61 as illustrated in FIG. 3.

As described with reference to FIG. 4B, in the positive bias purge, the transfer bias Vtr of the first polarity (e.g., positive polarity) is applied to the transfer roller 5. The transfer roller 5 rotates N times while the transfer voltage of the first polarity is being applied in the lubricating layer formation processing. The transfer roller 5 rotates M times while the transfer voltage of the second polarity is being applied in the lubricating layer formation processing. M is an integer greater than N. FIG. 4B illustrates an example in which N is 2. In the transfer cleaning, the transfer bias Vtr of the second polarity (e.g., negative polarity) is applied to the transfer roller 5. FIG. 4B illustrates an example in which M is 5. N and M may be other numerical values. The amount of paper dust sticking to the transfer roller 5 can change according to the environmental conditions and the state of wear in the image forming apparatus 100. Accordingly, N and M may be adjusted or determined according to the environmental conditions and the state of wear in the image forming apparatus 100.

The polarity of the transfer bias Vtr used for the positive bias purge is the same as the polarity of the transfer bias Vtr for transferring the toner image to the recording medium P. This makes it possible to cause toner to stick to the transfer roller 5 efficiently. By supplying toner to the transfer roller 5, paper dust and toner sticking to the transfer roller 5 are collected on the photosensitive drum 1 together.

As described above, the cleaning voltage of the second polarity (e.g., the negative-polarity transfer bias Vtr) is applied to the transfer roller 5 in post-rotation executed after the image formation end. As a result, a trace amount of toner sticking to the transfer roller 5 may be collected on the photosensitive drum 1. The transfer cleaning is also executed in the initial purge. This cleans off the toner intentionally transferred onto the transfer roller 5.

As the size of the recording medium P increases, paper dust sticks to the transfer roller 5 more easily. Accordingly, the amount of toner contained in the purge image may be increased as the size of the recording medium P increases. Likewise, the amount of toner contained in the purge image may be reduced as the size of the recording medium P decreases.

When images are formed on a plurality of sheets of the recording medium P in succession, paper dust sticks to the transfer roller 5 more easily. Accordingly, the amount of toner contained in the purge image may be increased as the number of times images are formed in succession increases. Likewise, the amount of toner contained in the purge image may be reduced as the number of times images are formed in succession decreases.

The frequency with which the image forming apparatus 100 forms images on the recording medium P per unit time (e.g., 1 hour) varies depending on the user. Accordingly, the image forming apparatus 100 may perform image formation intermittently (intermittent operations). For example, if a next print job is input immediately after the previous print job has ended, the post-rotation purge is not executed, or the post-rotation purge is shortened, after which the next print job is started. In this case, the next print job will be started before the lubricating layer 300 is fortified. Accordingly, the amount of toner contained in the purge image may be increased as the time from when the previous image formation ends to when the next image formation starts (an intermission time) decreases. Alternatively, the amount of toner contained in the purge image may be increased as the frequency of intermittent operations increases.

When double-sided image formation is executed, the recording medium P on which an image has been formed on a first surface is circulated within the image forming apparatus 100, and an image is then formed on a second surface of the recording medium P. In other words, in double-sided image formation, the recording medium P is pinched and conveyed by conveyance rollers for a longer period of time. Double-sided image formation therefore produces more paper dust than single-sided image formation. Accordingly, the amount of toner contained in the purge image may be adjusted according to the ratio of the occurrence of double-sided image formation to single-sided image formation. For example, if the ratio of the occurrence of double-sided image formation to single-sided image formation is large, the amount of toner contained in the purge image is increased. If the ratio of the occurrence of double-sided image formation to single-sided image formation is small, the amount of toner contained in the purge image is reduced.

The controller 200 may adjust the size of the first developing agent image, the amount of developing agent contained in the first developing agent image, or the printing ratio of the first developing agent image in a direction parallel to the axis of rotation of the image carrier in accordance with the size of the recording medium P.

### 2. Second Embodiment

In the first embodiment, in the initial purge, toner is intentionally transferred to the transfer roller 5 by employing the positive bias purge, and the toner and the paper dust are collected together. Incidentally, when the installation environment of the image forming apparatus 100 is an environment which experiences low temperature and low humidity, it is more likely that the paper dust will become charged. As the amount of paper dust increases, the lubricating layer 300 is more likely to be broken down. Accordingly, in the second embodiment, the initial purge executed when the process cartridge 70 is new is further improved. The lubricating layer 300 is properly formed and reinforced for the new process cartridge 70 as a result.

### 2-1. Initial Purge

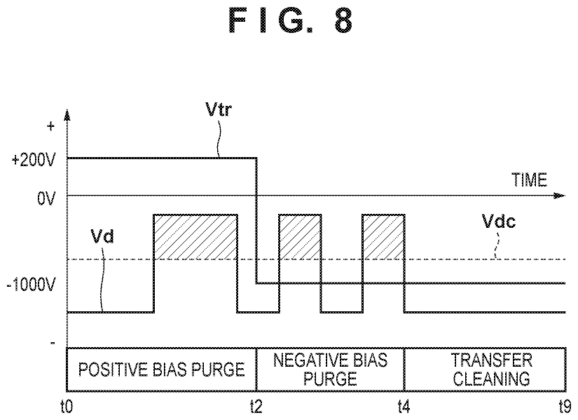

FIG. 8 illustrates a bias application sequence for the initial purge according to the second embodiment. As illustrated in FIG. 8, the feature of the initial purge according to the second embodiment is that a negative bias purge is added between the positive bias purge and the transfer cleaning of the first embodiment. In other words, in the second embodiment, a step is added which fortifies the lubricating layer 300 after the paper dust on the transfer roller 5 is collected with the toner by the cleaning blade 6.

The positive bias purge is as described in the first embodiment. The positive bias purge is executed in a period from time t0 to time t2. A purge image having a single toner pattern 50 mm long in the sub scanning direction is formed. The positive-polarity transfer bias Vtr (e.g., +200 V) is continuously applied to the transfer roller 5 during two rotations of the transfer roller 5. Note that the transfer bias Vtr may be determined according to the resistance value of the transfer roller 5, the resistance value of the photosensitive drum 1, and the environmental conditions (the ambient temperature and ambient humidity). For example, a table associating combinations of the resistance value of the transfer roller 5, the resistance value of the photosensitive drum 1, and the environmental conditions with the transfer bias Vtr may be stored in the memory 71 or the storage device 202. The CPU 201 may obtain the transfer bias Vtr corresponding to the combination of the resistance value of the transfer roller 5, the resistance value of the photosensitive drum 1, and the environmental conditions from the table. Note that a formula or a program module may be employed which outputs a corresponding transfer bias Vtr when the combination of the resistance value of the transfer roller 5, the resistance value of the photosensitive drum 1, and the environmental conditions is input.

The negative bias purge is executed in a period from time t2 to time t4. For example, a purge image having two toner patterns, each 5 mm long in the sub scanning direction, is formed. The negative-polarity transfer bias Vtr (e.g., −1,000 V) is continuously applied to the transfer roller 5 during two rotations of the transfer roller 5. The interval between the two toner patterns in the sub scanning direction is 20 mm, for example. Almost none of the toner carried on the photosensitive drum 1 is transferred to the transfer roller 5 while the negative-polarity transfer bias Vtr is applied to the transfer roller 5. However, the toner already stuck to the transfer roller 5 by the positive bias purge is retransferred from the transfer roller 5 to the photosensitive drum 1. The toner conveyed by the photosensitive drum 1 then forms the lubricating layer 300 in the cleaning contact part 61.

Finally, the transfer cleaning is executed in a period from time t4 to time t9. For example, the photosensitive drum 1 is rotationally driven to rotate the transfer roller 5 five times. As a result, toner that had been stuck to the transfer roller 5 is collected on the photosensitive drum 1. The lubricating layer 300 is fortified by the collected toner.

### 2-2. Flowchart

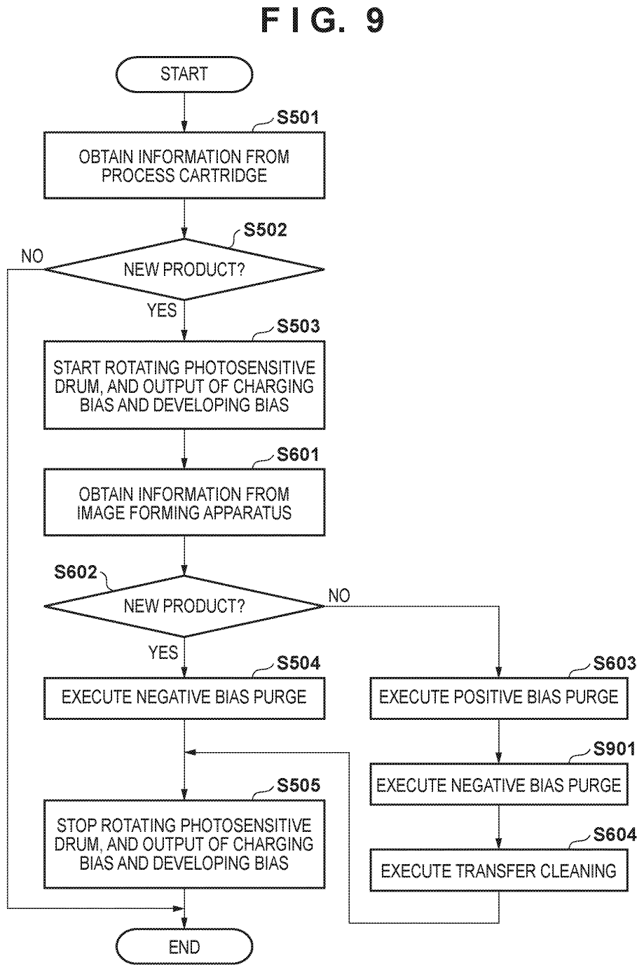

FIG. 9 is a flowchart illustrating a lubricating layer forming method according to the second embodiment. Compared to FIG. 6, step S901 has been added between step S603 and step S604. Steps already described in the first embodiment apply to the second embodiment as well. Once step S603 ends, the CPU 201 moves the sequence from step S603 to step S901.

In step S901, the CPU 201 (the image control unit 214, the voltage control unit 215, and the rotation control unit 216) executes the negative bias purge for fortifying the lubricating layer 300. As described above, two purge images are formed on the photosensitive drum 1 during two rotations of the transfer roller 5. The CPU 201 then moves the sequence from step S901 to step S604 and executes the transfer cleaning.

In the second embodiment, in the negative bias purge, a purge image containing two toner patterns is formed. However, this is merely one example. The number of toner patterns contained in the purge image, the interval between two adjacent toner patterns, and the length of the toner patterns in the sub scanning direction may be changed according to environmental conditions and the structure of the process cartridge 70.

### 2-3. Evaluation Experiments

FIG. 7B illustrates the results of evaluation experiments to confirm the effects of the comparative example, the first embodiment, and the second embodiment. Except for the environmental conditions, the other experiment conditions are as described in the first embodiment. The ambient temperature was 15° C. The ambient humidity was 10%. “Good” means that vertical streaks did not occur. “Fair” means that minor vertical streaks occurred at a level not problematic in terms of quality control. “Poor” means that vertical streaks occurred at a level problematic in terms of quality control.

In the comparative example, the evaluation of the first process cartridge 70 was “good”. The evaluation of the second process cartridge 70 was “poor”.

In the first embodiment, the evaluation of the first process cartridge 70 was “good”.

The evaluation of the second process cartridge 70 was “fair”. This is thought to be because in a low-temperature and low-humidity environment, a large amount of paper dust sticks to the transfer roller 5, and toner containing a large amount of paper dust reaches the cleaning contact part 61. As a result, the formation of the lubricating layer 300 is inhibited.

In the second embodiment, the evaluation of the first process cartridge 70 was “good”.

The evaluation of the second process cartridge 70 was “good”. In the second embodiment, the lubricating layer 300 is fortified by executing the negative bias purge after the positive bias purge. It is thought that the evaluation of the second process cartridge 70 was “good” as a result.

According to the second embodiment, a step of fortifying the lubricating layer 300 in the initial purge is added. This makes vertical streaks less likely to occur even under severe environmental conditions. In other words, the performance of the cleaning is maintained and a drop in image quality is suppressed, regardless of the environmental conditions.

As illustrated in FIG. 8, in a second period (a period including both the negative bias purge and the transfer cleaning), a second developing agent image for fortifying the lubricating layer may be formed on the photosensitive drum 1. The second developing agent image may be conveyed to the cleaning blade 6 as a result of the photosensitive drum 1 rotating. This further fortifies the lubricating layer 300. This approach is particularly useful under severe environmental conditions.

As illustrated in FIG. 8, the purge image in the negative bias purge may include a plurality of toner patterns.

As illustrated in FIG. 8, the length of each toner pattern included in the purge image for the negative bias purge (e.g., 5 mm) may be shorter than the length of the purge image for the positive bias purge (e.g., 50 mm).

As described with reference to FIG. 8, the interval between the plurality of toner patterns included in the purge image for the negative bias purge (e.g., 20 mm) may be longer than the length of each toner pattern (e.g., 5 mm).

The environment sensor 206 is an example of a detecting unit that detects an environmental condition of the environment in which the image forming apparatus 100 is installed. The controller 200 may adjust the number of times the first developing agent image is formed in the first period or the amount of developing agent contained in the first developing agent image in accordance with the environmental condition.

### 3. Third Embodiment

The first embodiment and the second embodiment are embodiments pertaining to the initial purge executed when the process cartridge 70 is new. However, the toner purge for maintaining the lubricating layer 300 may be performed at other times as well. Accordingly, the third embodiment proposes a post-rotation purge.

“Post-rotation purge” refers to a toner purge in a post-rotation operation after image formation. The post-rotation purge includes a positive bias purge. In other words, in the post-rotation purge, after the positive-polarity transfer bias Vtr is applied to the transfer roller 5 (the positive bias purge), the negative-polarity transfer bias Vtr is applied to the transfer roller 5 (the transfer cleaning). Paper dust sticking to the transfer roller 5 is integrated with the toner and conveyed to the cleaning contact part 61 by the post-rotation purge. This suppresses the accumulation of paper dust on the transfer roller 5. The third embodiment may be combined with the first embodiment or the second embodiment.

### 3-1. Post-Rotation Purge According to Comparative Example and Third Embodiment

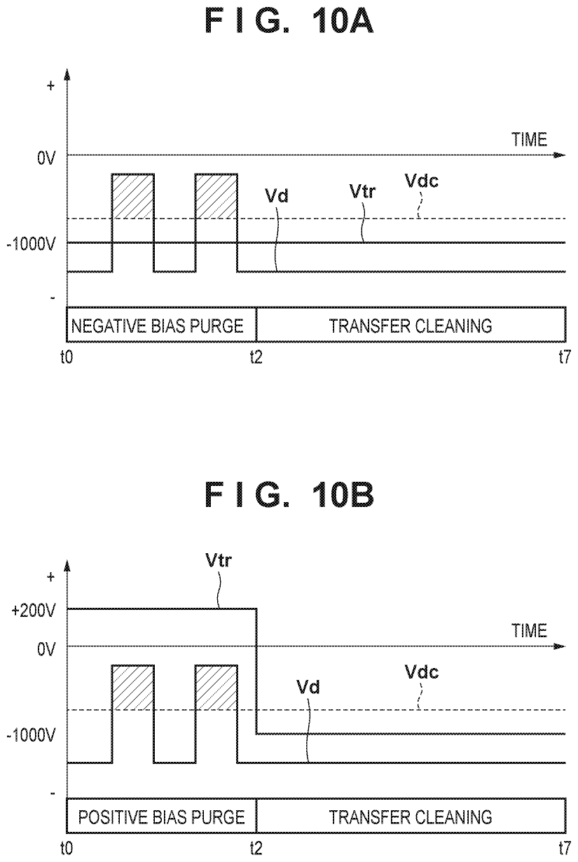

FIG. 10A illustrates a bias application sequence in a post-rotation purge according to a comparative example. FIG. 10B illustrates a bias application sequence in the post-rotation purge according to the third embodiment. The origin of the horizontal axis represents the timing at which image formation ends and the post-rotation purge begins.

As illustrated in FIG. 10A, the post-rotation purge according to the comparative example includes a negative bias purge and transfer cleaning. The negative bias purge is executed in a period from time t0 to time t2. This is a period equivalent to double the rotation period Tc of the transfer roller 5. The transfer cleaning is executed in a period from time t2 to time t7. This is a period equivalent to five times the rotation period Tc of the transfer roller 5.

When the post-rotation purge is started, a purge image is formed on the photosensitive drum 1 through an image formation process including charging, exposure, development, and transfer. The purge image for the post-rotation purge includes two toner patterns, for example. Each toner pattern is 2 mm long in the sub scanning direction. The interval between the two toner patterns is 23 mm. In the comparative example, the transfer bias Vtr is a negative-polarity voltage. The negative-polarity transfer bias Vtr is advantageous in that the toner is effectively supplied to the cleaning contact part 61 without toner being transferred to the transfer roller 5.

In the negative bias purge, the transfer roller 5 rotates twice. The transfer cleaning is then executed. As described above, in the transfer cleaning, the transfer roller 5 is rotated five times while the negative-polarity transfer bias Vtr is applied to the transfer roller 5. As a result, a trace amount of toner sticking to the transfer roller 5 is retransferred to the photosensitive drum 1, and the transfer roller 5 is cleaned. The toner re-transferred to the photosensitive drum 1 is cleaned by the cleaning blade 6.

The transfer bias Vtr in the negative bias purge and the transfer bias Vtr in the transfer cleaning may be determined according to the resistance value of the transfer roller 5, the resistance value of the photosensitive drum 1, and the environmental conditions. For example, if the ambient temperature is 15° C. and the ambient humidity is 10%, the transfer bias Vtr may be −1,000 V.

As illustrated in FIG. 10B, the post-rotation purge according to the third embodiment replaces the negative bias purge with a positive bias purge. In other words, the difference between the comparative example and the third embodiment is that the positive-polarity transfer bias Vtr is employed instead of the negative-polarity transfer bias Vtr. As such, the post-rotation purge according to the third embodiment includes a positive bias purge and transfer cleaning.

The positive bias purge is executed in a period from time t0 to time t2. This is a period equivalent to double the rotation period Tc of the transfer roller 5. The transfer cleaning is executed in a period from time t2 to time t7. This is a period equivalent to five times the rotation period Tc of the transfer roller 5.

In the third embodiment, the positive-polarity transfer bias Vtr required for retransferring the toner to the transfer roller 5 is +200 V, for example. However, this assumes that the ambient temperature is 15° C. and the ambient humidity is 10%. In the third embodiment, the purge image having two toner patterns is transferred to the transfer roller 5 by the positive bias purge. The transfer cleaning is executed after the positive bias purge. In the transfer cleaning, the negative-polarity transfer bias Vtr is applied, the toner is retransferred from the transfer roller 5 to the photosensitive drum 1, and the toner is conveyed to the cleaning contact part 61. The lubricating layer 300 is properly maintained as a result.

The length, in the sub scanning direction, of the purge image used in the initial purge described in the first embodiment and the second embodiment (e.g., 50 mm) is longer than the circumferential length of the transfer roller 5. This makes it possible for toner to stick uniformly to the entire circumferential surface of the transfer roller 5. On the other hand, the length, in the sub scanning direction, of the purge image used in the post-rotation purge of the third embodiment (e.g., 2 mm) is shorter than the circumferential length of the transfer roller 5. This is because the post-rotation purge is executed much more frequently than the initial purge. The amount of toner consumed is reduced by making the length of the purge image in the post-rotation purge relatively short. The interval between each of the plurality of toner patterns included in the purge image in the post-rotation purge is longer than the length of each toner pattern (e.g., 2 mm).

The condition for executing the post-rotation purge may be that the number of printed sheets has exceeded a predetermined threshold. Here, the number of printed sheets is a difference between the cumulative number of printed sheets the previous time the post-rotation purge was executed and the current (at the time of the determination) cumulative number of printed sheets.

The position at which the purge image is formed in the post-rotation purge (the position on the circumferential surface in the rotation direction) may be different between the previous time and the current time. As a result, the amount of toner sticking to the circumferential surface of the transfer roller 5 is made uniform, which increases the efficiency of the re-transfer to the photosensitive drum 1.

### 3-2. Flowchart

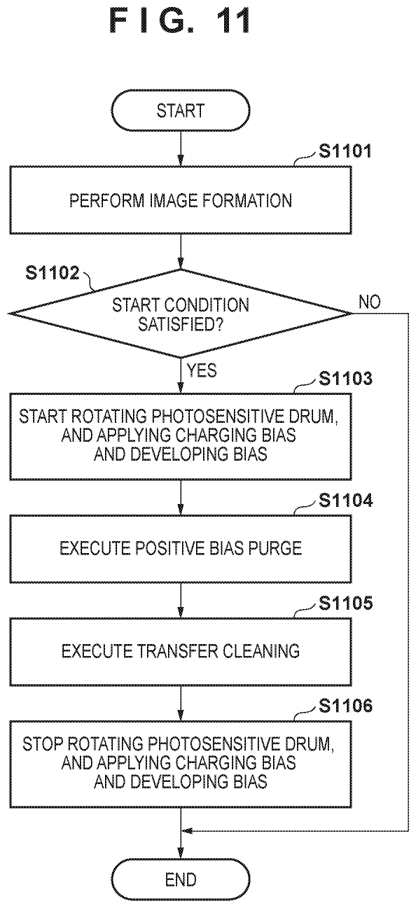

FIG. 11 is a flowchart illustrating the post-rotation purge according to the third embodiment.

In step S1101, the CPU 201 (the image control unit 214, the voltage control unit 215, and the rotation control unit 216) forms an image by controlling the image forming apparatus 100 based on a print job instructed by the user.

In step S1102, the CPU 201 (the start determination unit 211) determines whether a post-rotation purge start condition is satisfied. For example, the CPU 201 determines whether the number of printed sheets exceeds a threshold. If the start condition is satisfied, the CPU 201 moves the sequence from step S1102 to step S1103. If the start condition is not satisfied, the CPU 201 skips the post-rotation purge. For example, the CPU 201 executes normal post-rotation without a toner purge.

In step S1103, the CPU 201 (the image control unit 214, the voltage control unit 215, and the rotation control unit 216) starts rotating the photosensitive drum 1, applying the charging bias Vd, and applying the developing bias Vdc to form the purge image for the post-rotation purge on the photosensitive drum 1. For example, the charging bias Vd is −1,100 V. The developing bias Vdc is −400 V.

In step S1104, the CPU 201 (the image control unit 214, the voltage control unit 215, and the rotation control unit 216) executes the positive bias purge. The CPU 201 controls the scanner unit 3 to form an electrostatic latent image on the photosensitive drum 1, and causes the developing device 4 to form the purge image using toner.

When the photosensitive drum 1 rotates, the purge image is conveyed to the transfer roller 5. As illustrated in FIG. 10B, the transfer bias Vtr is set to a positive bias (e.g., +200 V). Most of the purge image is therefore transferred to the transfer roller 5.

In step S1105, the CPU 201 (the voltage control unit 215 and the rotation control unit 216) executes the transfer cleaning. The CPU 201 switches the transfer bias Vtr from a positive polarity bias (e.g., +200 V) to a negative polarity bias (e.g., −1,000 V). As a result, the toner is re-transferred from the transfer roller 5 to the photosensitive drum 1, and conveyed to the cleaning blade 6 by the photosensitive drum 1. At this time, paper dust sticking to the transfer roller 5 is also collected on the photosensitive drum 1 along with the toner, and is conveyed to the cleaning blade 6. As a result, the paper dust is removed from the transfer roller 5, and the lubricating layer 300 is properly fortified.

In step S1106, once the transfer cleaning is complete, the CPU 201 (the voltage control unit 215 and the rotation control unit 216) stops the rotation of the photosensitive drum 1, the output of the charging bias Vd, and the output of the developing bias Vdc. The output of the transfer bias Vtr is also stopped.

In the comparative example, the negative bias purge is executed instead of the positive bias purge in step S1104.

This is as illustrated in FIG. 10A.

### 3-3. Evaluation Experiments

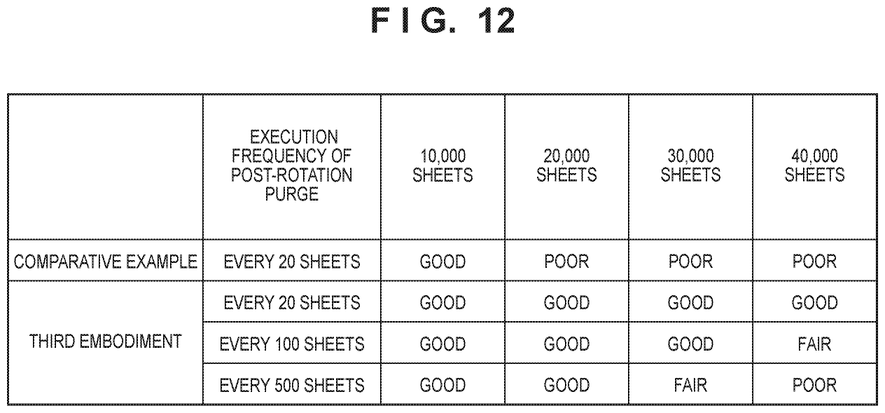

FIG. 12 illustrates the results of evaluation experiments. Experiments were performed for the comparative example and the third embodiment under the same environmental conditions. The initial purge according to the first embodiment was executed before the post-rotation purge according to the comparative example and the post-rotation purge according to the third embodiment, respectively.

More severe experiment conditions were used in the evaluation experiments. Specifically, paper left in a low-temperature, low-humidity environment (ambient temperature=15° C., ambient humidity=10%), where paper dust is likely to be produced, was used. The environmental conditions at the time of image formation were the same. A horizontal line image having a printing ratio of 2% was used as a depletion image for depleting the process cartridge 70. The depletion image was formed successively on 40,000 sheets of the recording medium P. However, each time the depletion image was printed on 10,000 sheets of the recording medium P, a halftone image having a printing ratio of 25% was printed on the recording medium P as a test image for evaluating the cleaning performance. Whether vertical streaks had been produced due to toner soiling of the charging roller 2 was then confirmed. The definitions of “good”, “fair”, and “poor” were as described above.

As illustrated in FIG. 12, in the comparative example, the post-rotation purge was executed each time a depletion image was formed on 20 sheets of the recording medium P. The charging roller 2 was highly soiled by additives that had slipped past the cleaning blade 6. As a result, vertical streaks were seen in the test image formed on the recording medium P after the depletion images had been formed on 20,000 sheets of the recording medium P.

The frequency at which the post-rotation purge according to the third embodiment was executed was every 20 sheets, every 100 sheets, and every 500 sheets. When the post-rotation purge according to the third embodiment was executed every 20 sheets, almost no soiling from additives that had slipped past the cleaning blade 6 was found on the charging roller 2. Furthermore, no vertical streaks were found when the number of printed sheets reached 40,000.

When the post-rotation purge according to the third embodiment was executed every 100 sheets, only minor soiling of the charging roller 2 from additives occurred. Furthermore, only minor vertical streaks occurred when the number of printed sheets reached 40,000.

When the post-rotation purge according to the third embodiment was executed every 500 sheets, soiling of the charging roller 2 from additives was relatively greater. Very slight vertical streaks were found when the number of printed sheets exceeded 30,000 sheets. The vertical streak became more pronounced when the number of printed sheets reached 40,000.

In the third embodiment, in the post-rotation, a purge image is supplied to the transfer roller 5 to which paper dust is stuck, and the toner and the paper dust electrostatically and physically stick to the photosensitive drum 1. As a result, the toner and the paper dust are removed by the cleaning blade 6. Since the toner and the paper dust are integrated and conveyed to the cleaning contact part 61, it is difficult for the paper dust to be conveyed to the cleaning contact part 61 alone. The lubricating layer 300 is properly maintained as a result. The occurrence of vertical streaks due to a drop in cleaning performance is also suppressed.

According to the third embodiment, the length, in the sub scanning direction, of the two toner patterns included in the purge image of the post-rotation purge is 2 mm, for example. However, this is merely one example. The purge image may be changed depending on the size of the recording medium P, sheet passage conditions, the environmental conditions, the state of wear in the process cartridge 70, and the state of wear in the image forming apparatus 100. Specifically, the amount of toner consumed to form the purge image, the number of toner patterns, the length of the toner pattern in the sub scanning direction, and the supply ratio of the toner in the main scanning direction may be changed. Here, the sheet passage conditions include the number of consecutive printed sheets, the frequency of intermittent operations, the image forming mode (double-sided printing/single-sided printing), and the like. “Intermittent operation” means that image forming is repeated intermittently due to print jobs being submitted continuously or a short time interval between a preceding print job and a subsequent print job.

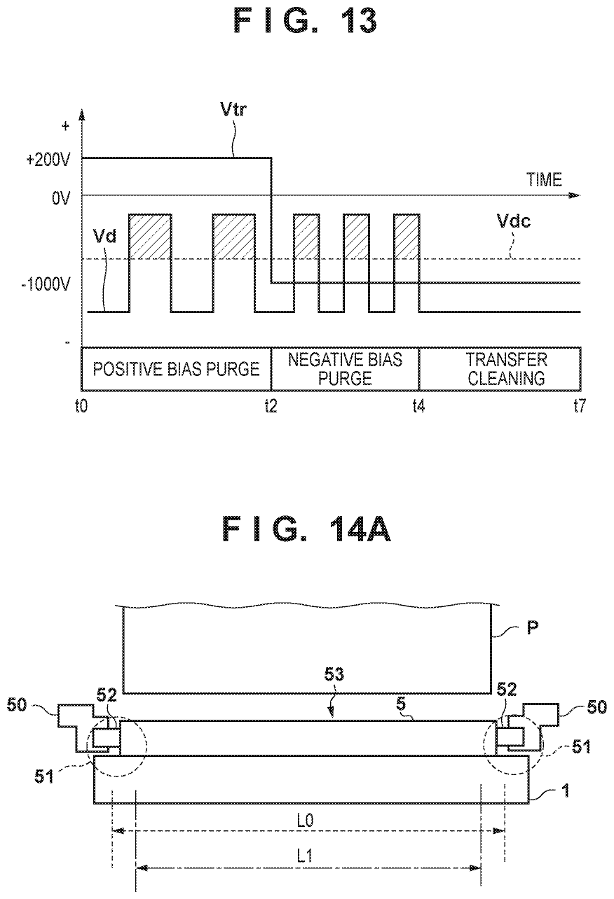

As illustrated in FIG. 13, the post-rotation purge according to the third embodiment may include a negative bias purge between the positive bias purge and the transfer cleaning. The positive bias purge is executed in a period from time t0 to time t2. This is a period equivalent to double the rotation period Tc of the transfer roller 5. The negative bias purge is executed in a period from time t2 to time t4. This is a period equivalent to double the rotation period Tc of the transfer roller 5. The transfer cleaning is executed in a period from time t4 to time t9. This is a period equivalent to five times the rotation period Tc of the transfer roller 5.

The purge image for the negative bias purge may be different from the purge image for the positive bias purge. For example, the purge image for the negative bias purge formed during two rotations of the transfer roller 5 may include three toner patterns. The length of each toner pattern in the sub scanning direction may be 1 mm, for example. The addition of the negative bias purge makes it possible to even more appropriately maintain the lubricating layer 300 formed at the cleaning contact part 61.

As illustrated in FIGS. 10 and 13, cleaning processing for the image carrier (the post-rotation purge) may be performed in the period after the formation of the developing agent image on the recording medium P ends. As a result, paper dust sticking to the transfer roller 5 is cleaned, and the lubricating layer 300 is properly maintained. FIGS. 10 and 13 illustrate an example of a third developing agent image. A purge similar to the post-rotation purge may be executed in a suspension period of the print job in which developing agent images are consecutively formed on a plurality of sheets of the recording medium P. By executing the post-rotation purge, toner and paper dust are cleaned from the transfer roller 5, and the lubricating layer 300 is properly maintained. When continuous printing is executed, the timing at which the post-rotation purge is executed may be delayed, and a large amount of paper dust may stick to the transfer roller 5. Accordingly, a toner purge equivalent to the post-rotation purge may be executed during the suspension period of the print job.

As illustrated in FIGS. 10 and 13, the third developing agent image (the purge image) may include a plurality of toner patterns.

As mentioned in the third embodiment, the length of each toner pattern included in the purge image for the post-rotation purge (e.g., 2 mm) may be shorter than the length of the toner pattern for the initial purge (e.g., 50 mm). The lubricating layer 300 is incomplete in the initial purge, and more toner is therefore required. In the post-rotation purge, however, the lubricating layer 300 is already formed, and the amount of toner required to maintain the lubricating layer 300 is therefore relatively low.

As mentioned in the third embodiment, the interval between the toner patterns may be longer than the length of each toner pattern. This is because in the post-rotation purge, the amount of toner required to maintain the lubricating layer 300 is low.

### 4. Fourth Embodiment

### 4-1. Overview

In the first to third embodiments, the length of the purge image in the main scanning direction of each purge is set to be equal to, for example, the width of the photosensitive drum 1 (the length in a direction parallel to the main scanning direction). However, when the positive bias purge is executed at the width of the photosensitive drum 1, toner and paper dust from the recording medium P may scatter inside the image forming apparatus 100.

Accordingly, in the fourth embodiment, the initial purge executed when the process cartridge 70 is new is further improved. Specifically, the lubricating layer 300 is formed appropriately while suppressing the scattering of toner and paper dust in the image forming apparatus 100. Although a feature of the first embodiment is that the positive bias purge and transfer cleaning are included, the fourth embodiment has a feature that the length of the purge image in the main scanning direction for the positive bias purge is regulated.

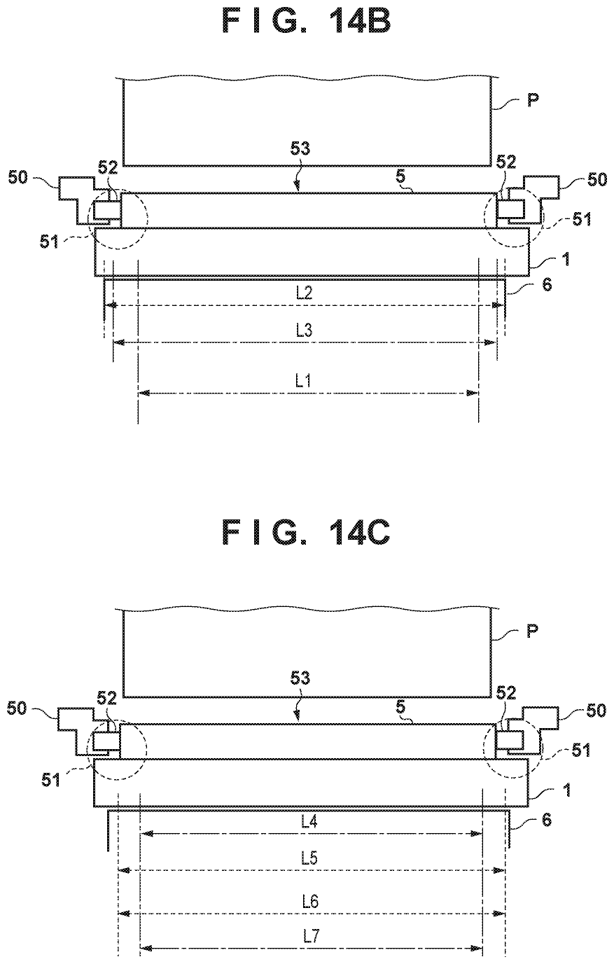

FIG. 14A illustrates the transfer roller 5, the recording medium P, and the photosensitive drum 1 arranged along the main scanning direction. The transfer roller 5 is constituted by a metal core 52 serving as the rotational center and a conductive sponge 53 that covers the outside of the metal core 52. The sponge 53 has a substantially cylindrical shape. The length of the transfer roller 5 in a rotation axis direction (a direction parallel to the main scanning direction) mentioned hereinafter is the length of the sponge 53. A plurality of open cells are present on the surface of the sponge 53. Toner and paper dust accumulate in the cells. A bearing 50 that rotatably holds the metal core 52 of the transfer roller 5 is disposed at the two ends of the transfer roller 5 illustrated in FIG. 14A and the like. The two bearings 50 are configured such that the two bearings 50 can be removed when the transfer roller 5 is replaced. The two bearings 50 may be touched by the user when replacing the transfer roller 5, and the two bearings 50 must not be soiled by toner, paper dust, or the like.

In the positive bias purge, the transfer bias Vtr is set to the positive polarity bias, and the toner in the developing device 4 sticks to the transfer roller 5. When the transfer bias Vtr is switched from the positive polarity bias to the negative polarity bias, paper dust carried on the transfer roller 5 is retransferred to the photosensitive drum 1 along with the toner. Toner and paper dust stuck to the ends of the transfer roller 5 may scatter during this re-transfer. The scattering occurs in a region 51 that is further outside than the ends of the sponge 53 in the rotation axis direction of the metal core 52. This phenomenon occurs when toner and paper dust are stuck to the ends of the sponge 53 of the transfer roller 5, and toner and paper dust inside the sponge 53 are pushed outward. Accordingly, it is conceivable to regulate a length L1 of the purge image in the main scanning direction when executing the positive bias purge in order to prevent scattering at the ends of the transfer roller 5. In the fourth embodiment, the length of the transfer roller 5 in the main scanning direction is shorter than the length of the photosensitive drum 1 in the main scanning direction, but this is merely one example. The length of the transfer roller 5 in the main scanning direction may be longer than the length of the photosensitive drum 1 in the main scanning direction.

At the point in time when the purge image is formed during the execution of the positive bias purge, the length of the purge image in the main scanning direction (e.g., L0) may exceed the length of the transfer roller 5 in the rotation axis direction. In this case, toner will be supplied as far as the ends of the transfer roller 5, and there is a strong chance that the toner will scatter in the direction of the bearings 50 or that the interior of the image forming apparatus 100 will be soiled by toner. Accordingly, as illustrated in FIG. 14A, in the fourth embodiment, when executing the positive bias purge, processing is performed to make the length L1 of the purge image in the main scanning direction shorter than the length of the transfer roller 5 in the rotation axis direction. The processing further improves the initial purge, providing a unit that is effective against the scattering of toner, and properly forming and fortifying the lubricating layer 300 for a new process cartridge 70. In this manner, in a direction parallel to the axis of rotation of the image carrier, the length of the developing agent image in the first period is shorter than a length of the transfer unit.

The initial purge may be skipped if the process cartridge 70 is not new. Through this, downtime due to the initial purge may be reduced. The fourth embodiment may be combined with the third embodiment.

### 4-2. Evaluation Experiments

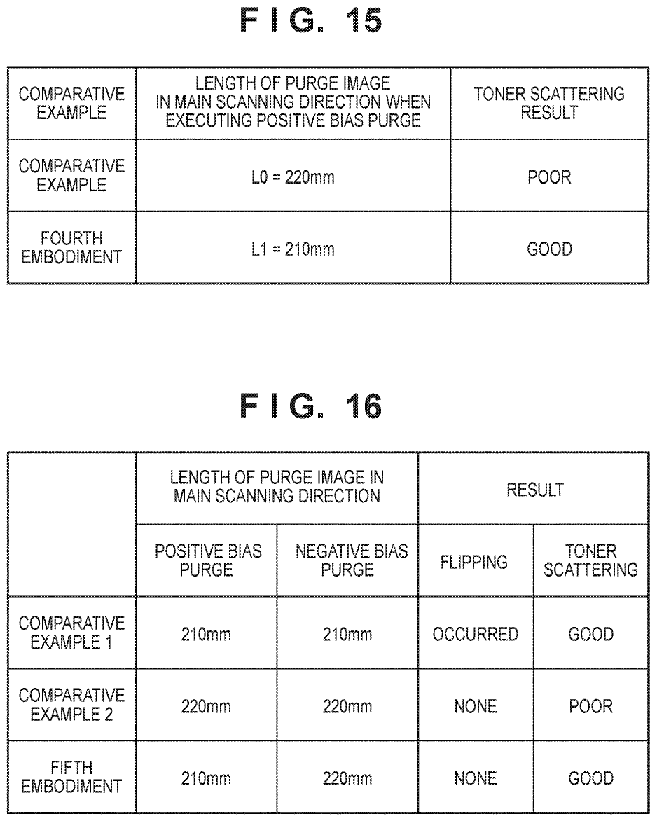

FIG. 15 illustrates the results of evaluation experiments. Experiments were performed for the comparative example and the fourth embodiment under the same environmental conditions.

In the evaluation experiments, paper left in a low-temperature, low-humidity environment (ambient temperature=15° C., ambient humidity=10%), where paper dust is likely to be produced, was used, in the same manner as in the third embodiment. The environmental conditions at the time of image formation were the same. The length of the recording medium P in the main scanning direction was 216 mm, which is the maximum width that can be set in the image forming apparatus 100. The sponge 53 of the transfer roller 5 was 218 mm in length.

Whether scattering occurred after the initial purge was executed for a new process cartridge 70, and whether scattering occurred outward from the ends of the transfer roller 5 in the main scanning direction, were confirmed. When the experimenter's hands that touched the bearing 50 were soiled by toner, the scattering evaluation was determined to be “poor”. Conversely, the evaluation was “good” when no soiling occurred.

As illustrated in FIGS. 14A and 15, in the comparative example, the length L0 of the purge image in the main scanning direction during the execution of the initial purge (the positive bias purge) was longer than the length of the sponge 53. In other words, L0 was 220 mm. Toner scattering was confirmed when the ends of the transfer roller 5 and the bearings 50 were touched after the initial purge was executed. During the execution of the positive bias purge, when the transfer bias Vtr was a negative polarity, the length L0 of the purge image in the main scanning direction exceeded the length of the sponge 53 of the transfer roller 5. As a result, toner scattered from the ends of the transfer roller 5 in contact with the photosensitive drum 1, and the bearings 50 were soiled with toner and the like.

As illustrated in FIG. 14A, in the fourth embodiment, the length L1 in the main scanning direction when executing the positive bias purge is 210 mm. Toner scattering was not confirmed at the ends of the transfer roller 5 and the bearings 50 after the initial purge was executed. The length L1 of the purge image in the main scanning direction when executing the negative polarity bias is at most the length of the sponge 53 of the transfer roller 5. This is thought to be because the length L1 of the purge image is such that toner does not scatter from the ends of the sponge 53 of the transfer roller 5 to the bearings 50, and the toner and paper dust were therefore retransferred from the transfer roller 5 to the photosensitive drum 1.

According to the fourth embodiment, the length L1, in the main scanning direction, of the toner pattern for the positive bias purge is merely one example. The purge image may be changed depending on the size of the recording medium P, the sheet passage conditions, the environmental conditions, the state of wear in the process cartridge 70, the length in the axial direction of the transfer roller 5, or the state of wear in the image forming apparatus 100. Specifically, the amount of toner consumed to form the purge image, the number of toner patterns, the length of the toner pattern in the sub scanning direction, and the supply ratio of the toner in the main scanning direction may be changed.

### 5. Fifth Embodiment

### 5-1. Overview

In the fourth embodiment, the length of the purge image in the main scanning direction during the execution of the positive bias purge was regulated to prevent toner scattering. However, when scattering is prevented, it is necessary to suppress flipping of the cleaning blade 6 at the same time.

In a state where the length, in the main scanning direction, of the purge image for the positive bias purge has been made shorter than the length of the transfer roller 5, toner and paper dust retransferred to the photosensitive drum 1 do not extend to the ends of the photosensitive drum 1, and the conveyance of toner to the cleaning blade 6 is delayed. If the cleaning blade 6, on which toner does not extend to the ends, slides along the photosensitive drum 1 when the initial purge is executed, the lubricating layer 300 will not be formed at the ends. This increases the friction acting between the cleaning blade 6 and the photosensitive drum 1. As a result, the cleaning blade 6 is more likely to flip. To suppress flipping, it is necessary for purged toner to be distributed to the ends of the cleaning blade 6.

Accordingly, in the fifth embodiment, the initial purge of the second embodiment is further improved based on the fourth embodiment. In the second embodiment, the positive bias purge, the negative bias purge, and the transfer cleaning were executed in that order. The fifth embodiment regulates the length of the purge image in the main scanning direction based on the fourth embodiment, and also regulates the length of the purge image in the main scanning direction for the negative bias purge. As a result, in the positive bias purge, the scattering of toner and paper dust is reduced while also collecting toner and paper dust on the photosensitive drum 1.

To suppress flipping of the cleaning blade 6, it is necessary for paper dust and toner to be properly supplied to the photosensitive drum 1 in the main scanning direction during the execution of the negative bias purge. As illustrated in FIG. 14B, it is necessary for the negative bias purge to be executed from one end to the other end in the main scanning direction of the cleaning blade 6 (across the entire width of the cleaning blade 6). However, the toner reaches the endmost parts of the cleaning blade 6 even if the negative bias purge is not executed across the entire width of the cleaning blade 6. As illustrated in FIG. 14B, if a length L3 of the purge image in the main scanning direction is longer than the length of the transfer roller 5 and shorter than a length L2 of the cleaning blade 6, the purge image will not reach the ends of the cleaning blade 6. In actuality, the toner is conveyed laterally when the purge is executed, and the toner is replenished as far as to the endmost parts of the cleaning blade 6. In other words, to suppress flipping of the cleaning blade 6, the length L3, in the main scanning direction, of the purge image in the negative bias purge is set to be at least the length of the transfer roller 5 and at most the length L2 of the cleaning blade 6. Accordingly, as illustrated in FIG. 14B, the length L3, in the main scanning direction, of the purge image for the negative bias purge in the fifth embodiment is set to be longer than the length L1, in the main scanning direction, of the purge image for the positive bias purge in the fourth embodiment. Note that the length of the purge image in the sub scanning direction and the transfer bias, the execution time of the positive bias purge and the negative bias purge, and the flowchart are as described in the second embodiment. The fifth embodiment may be combined with the third embodiment. In this manner, in the fifth embodiment, in a direction parallel to the axis of rotation of the image carrier, a length of the developing agent image in the first period (e.g., L1) is shorter than a length of the developing agent image in the second period (e.g., L3). In addition, in a direction parallel to the axis of rotation of the image carrier, the length of the cleaning unit (e.g., L2) is longer than the length of the transfer unit, and the length of the developing agent image in the second period (e.g., L3) is longer than the length of the transfer unit.

### 5-2. Evaluation Experiments

FIG. 16 illustrates the results of evaluation experiments. Experiments were performed for Comparative Examples 1 and 2 and the fifth embodiment under the same environmental conditions.

In the evaluation experiments, paper left in a low-temperature, low-humidity environment (ambient temperature=15° C., ambient humidity=10%), where paper dust is likely to be produced, was used, in the same manner as in the fourth embodiment. The environmental conditions at the time of image formation were the same. The length of the recording medium P in the main scanning direction was 216 mm, which is the maximum width that can be set in the image forming apparatus 100. The sponge 53 of the transfer roller 5 was 218 mm in length. The length of the cleaning blade 6 in the main scanning direction was 235 mm.

Whether scattering occurred after the initial purge was executed for a new process cartridge 70, and whether scattering occurred outward from the ends of the transfer roller 5 in the main scanning direction, were confirmed. When the experimenter's hands that touched the bearing 50 were soiled by toner, the scattering evaluation was determined to be “poor”. Conversely, the evaluation was “good” when no soiling occurred. Whether flipping had occurred at the ends of the cleaning blade 6 after the initial purge was executed was confirmed.

As illustrated in FIG. 14C, in Comparative Example 1, the length L4 of the purge image in the main scanning direction during the execution of the initial purge was 210 mm for both the positive bias purge and the negative bias purge. Toner scattering was not found at the ends of the transfer roller 5 and the bearings 50 after the initial purge was executed. However, flipping was found at the ends of the cleaning blade 6. When executing the negative bias purge, the length L4 of the purge image in the main scanning direction is shorter than the length of the transfer roller 5. Accordingly, the toner is not conveyed to the ends of the cleaning blade 6 further outside the part corresponding to the purge image. Therefore, the lubricating layer 300 is not properly formed, which increases friction and may cause flipping.

As illustrated in FIG. 14C, in Comparative Example 2, a length L5 of the purge image in the main scanning direction during the initial purge was 220 mm for both the positive bias purge and the negative bias purge. Toner scattering was confirmed when the ends of the transfer roller 5 and the bearings 50 were touched after the initial purge was executed. When executing the positive bias purge, the length L5 of the purge image in the main scanning direction exceeds the length of the sponge 53 of the transfer roller 5. When the ends of the transfer roller 5 contact the photosensitive drum 1, toner scattered from the ends of the transfer roller 5, and the bearings 50 were soiled with toner and the like.

However, no abnormalities were found in the cleaning blade 6. This is thought to be because when executing the negative bias purge, the length of the purge image in the main scanning direction exceeds the length (width) of the transfer roller 5. Toner was therefore conveyed laterally as far as the ends of the cleaning blade 6, ensuring friction did not arise and flipping did not occur.

On the other hand, in the fifth embodiment, a length L7 of the purge image in the main scanning direction during the execution of the positive bias purge is 210 mm. A length L6 of the purge image in the main scanning direction when executing the negative bias purge is 220 mm. Toner scattering was not found at the ends of the transfer roller 5 and the bearings 50 after the initial purge was executed, and no flipping in the cleaning blade 6 was found. The length L7 of the purge image in the main scanning direction when executing the positive bias purge is at most the length of the transfer roller 5 in the axial direction. As a result, the toner was re-transferred to the photosensitive drum 1 such that the toner did not scatter at the ends where the bearings 50 are located. When executing the negative bias purge, the length L6 of the purge image in the main scanning direction is longer than the length of the transfer roller 5. Accordingly, the length L6 of the purge image was close to the length of the cleaning blade 6, and the lubricating layer 300 was formed up to the endmost parts of the cleaning blade 6, ensuring that flipping did not occur.

In the fifth embodiment, the length L7, in the main scanning direction, of the purge image for the positive bias purge was made shorter than the length of the transfer roller 5, and the length L6, in the main scanning direction, of the purge image for the negative bias purge was made longer than the length of the transfer roller 5. This made it possible to both suppress the scattering of toner at the ends of the transfer roller 5 and suppress flipping of the cleaning blade 6.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-045617, filed Mar. 19, 2025 and Japanese Patent Application No. 2025-154411, filed Sep. 17, 2025 which are hereby incorporated by reference herein in their entirety.

What is claimed is:

1. An image forming apparatus comprising:
an image carrier;
a drive unit configured to rotationally drive the image carrier;
a developing unit configured to supply a developing agent to the image carrier being rotationally driven and form a developing agent image;
a transfer unit configured to transfer the developing agent image from the rotationally driven image carrier to a recording medium;
an applying unit configured to apply a voltage of a first polarity or a voltage of a second polarity to the transfer unit;
a cleaning unit that is disposed downstream of the transfer unit in a rotation direction of the image carrier and configured to clean a surface of the image carrier by coming into contact with the rotationally driven image carrier;
a process cartridge configured to house the image carrier, the developing unit, and the cleaning unit; and
a control unit configured to control the drive unit, the developing unit, and the applying unit,
wherein the control unit is configured to execute supply processing for supplying a developing agent between the cleaning unit and the image carrier in a case where the image forming apparatus is not new and the process cartridge is new, and
the supply processing includes:
rotationally driving the image carrier by the drive unit;
forming a first developing agent image on the image carrier by the developing unit;
applying, by the applying unit, a transfer voltage of the first polarity to the transfer unit to transfer the first developing agent image from the image carrier to the transfer unit in a first period including a period in which the first developing agent image carried on the image carrier passes the transfer unit; and
applying, by the applying unit, a transfer voltage of the second polarity to the transfer unit to transfer the developing agent image from the transfer unit to the image carrier in a second period after the first developing agent image carried on the image carrier passes the transfer unit.

2. The image forming apparatus according to claim 1,
wherein the process cartridge includes a holding unit configured to hold information indicating whether the process cartridge is new, and
the control unit is configured to determine whether the process cartridge is new based on the information held by the holding unit.

3. The image forming apparatus according to claim 1, further comprising:
a storage unit configured to store information indicating whether the image forming apparatus is new,
wherein the control unit is configured to determine whether the image forming apparatus is new based on the information stored in the storage unit.

4. The image forming apparatus according to claim 1,
wherein the transfer unit is a rotating body, and
a length of the first developing agent image in a rotation direction of the rotating body is equal to or longer than a circumferential length of the rotating body.

5. The image forming apparatus according to claim 1,
wherein the cleaning unit includes:
a cleaning member that is blade-like and configured to come into contact with the image carrier; and
a collecting container configured to collect the developing agent image collected by the cleaning member.

6. The image forming apparatus according to claim 5,
wherein a lubricating layer of the developing agent is formed at an area of contact between the cleaning member and the image carrier.

7. The image forming apparatus according to claim 4,
wherein the rotating body rotates N times while the transfer voltage of the first polarity is being applied in the supply processing,
the rotating body rotates M times while the transfer voltage of the second polarity is being applied in the supply processing, and
M is an integer greater than N.

8. The image forming apparatus according to claim 1,
wherein in the supply processing, the developing unit forms, on the image carrier, a second developing agent image for fortifying a lubricating layer of the developing agent formed at an area of contact between the cleaning unit and the image carrier, in the second period, and
the second developing agent image is conveyed to the cleaning unit by the image carrier rotating.

9. The image forming apparatus according to claim 8, wherein the second developing agent image includes a plurality of images.

10. The image forming apparatus according to claim 9,
wherein a length, in the rotation direction of the image carrier, of each of the plurality of images included in the second developing agent image, is shorter than a length of the first developing agent image.

11. The image forming apparatus according to claim 10,
wherein an interval between the plurality of images in the rotation direction of the image carrier is longer than the length of each of the plurality of images.

12. The image forming apparatus according to claim 1, further comprising:
a detecting unit configured to detect an environmental condition of an environment in which the image forming apparatus is installed,
wherein the control unit adjusts a total number of times the first developing agent image is formed in the first period or an amount of the developing agent in the first developing agent image, in accordance with the environmental condition.

13. The image forming apparatus according to claim 1,
wherein the first polarity corresponds to a polarity of a voltage used when transferring the developing agent image from the image carrier to the recording medium.

14. The image forming apparatus according to claim 1,
wherein the second polarity corresponds to a polarity of a cleaning voltage applied to the transfer unit after transfer of the developing agent image from the image carrier to the recording medium ends.

15. The image forming apparatus according to claim 1,
wherein in a direction parallel to an axis of rotation of the image carrier, a length of the developing agent image in the first period is shorter than a length of the transfer unit.

16. The image forming apparatus according to claim 8,
wherein in a direction parallel to an axis of rotation of the image carrier, a length of the developing agent image in the first period is shorter than a length of the developing agent image in the second period.

17. The image forming apparatus according to claim 8,
wherein in a direction parallel to an axis of rotation of the image carrier, a length of the cleaning unit is longer than a length of the transfer unit, and a length of the developing agent image in the second period is longer than a length of the transfer unit.

18. The image forming apparatus according to claim 1,
wherein the control unit is configured to execute cleaning processing of the image carrier in a period after formation of the developing agent image on the recording medium ends or in a suspension period in a print job in which developing agent images are consecutively formed on a plurality of recording media, and
the cleaning processing includes:
rotationally driving the image carrier by the drive unit;
forming a third developing agent image on the image carrier by the developing unit;
applying, by the applying unit, a transfer voltage of the first polarity to the transfer unit to transfer the third developing agent image from the image carrier to the transfer unit in a third period including a period in which the third developing agent image carried on the image carrier passes the transfer unit; and
applying, by the applying unit, a transfer voltage of the second polarity to the transfer unit to transfer the developing agent image and a sticking substance from the transfer unit to the image carrier in a fourth period after the third developing agent image carried on the image carrier passes the transfer unit.
